(19) United States
(12) Patent Application Publication
(10) Pub. No.: US 2026/0277718 A1
(43) Pub. Date: Sep. 17, 2026

(54) ASSET TRACKING AND PREDICTIVE RELIABILITY ANALYSIS ACROSS DISTRIBUTED COMPUTING SYSTEMS

(71) Applicant: Unify Point, Inc., Palo Alto, CA (US)

(72) Inventors: Geoffrey Daniel Mershon, Palo Alto, CA (US); Amresh Prasad, Sunnyvale, CA (US); Robert Brian Walker, Milpitas, CA (US); Deepali Sameet Joshi, Mountain View, CA (US)

(21) Appl. No.: 19/566,197

(22) Filed: Mar. 13, 2026

Related U.S. Application Data
(60) Provisional application No. 63/772,300, filed on Mar. 14, 2025.

(51) Int. Cl. G06F 11/00

(52) U.S. Cl. CPC G06F 11/004; G06F 11/006; G06F 2201/81

(57) ABSTRACT

The disclosed approaches describe predictively identifying failures using long-term information. A method, comprises: receiving, from software agents, telemetry data objects associated with operation of hardware components installed on the computing systems, wherein the telemetry data objects include chassis position of the hardware components in the fleet of computing systems; obtaining reliability metrics associated with the hardware components based on the telemetry data objects; analyzing the telemetry data objects and the reliability metrics by using a component performance algorithm; and identifying a hardware component in a computing system indicative of a hardware failure based on results of the component performance algorithm; and updating a maintenance dashboard with the results of the component performance algorithm, wherein the maintenance dashboard identifies the hardware component indicative of the hardware failure, including the chassis position of the hardware component in the computing system.

### CROSS REFERENCE TO RELATED APPLICATION

This application claims the benefit of U.S. Provisional Application No. 63/772,300 filed Mar. 14, 2025, the content of which is incorporated by reference herein in its entirety.

### BACKGROUND

### TECHNICAL FIELD

The technical field of the disclosure relates to predictive and preventative maintenance for hardware components of a computing system by deploying software agents to the computing system to obtain telemetry data objects associated with the hardware components and apply remediation repairs as necessary.

### DESCRIPTION OF THE RELATED ART

Enterprises struggle to predict maintenance and identify failures of hardware components across a computing infrastructure using traditional approaches. Traditional approaches to monitor components in the computing infrastructure rely on outdated protocols. For example, the protocols include intelligent platform management interface (IPMI) and simple network management protocol (SNMP), which are used to provide alerts and performance monitoring of components across a computing infrastructure. IPMI provides low-level, hardware-specific, out-of-band management (for example, power cycling, temperature sensors) independent of an operating system (OS). SNMP is a broader protocol for monitoring performance of network devices (routers, switches), server OS metrics, and performance.

Due to protocol limitations, traditional approaches collect incomplete or outdated component data. Traditional approaches relying on IPMI protocols provide sensor data records as data tables. The data tables have fixed format fields and often omit newer metadata. The data collected often lacks granular identifiers, such as vendor, model, firmware version, slot location, and serial numbers. Additionally, SNMP relies on device management information bases, which are a structured collection of information to define properties of managed objects within a device. In general, management information bases define generic attributes (for example, the base sensor readings). There is no granularity on a per component basis and the results are static fields. Thus, the existing protocols face limitations to granular data collection of hardware components.

Traditional approaches generate excessive alerts with little actionable context. The traditional approaches monitor raw sensor data records and check alerts whenever the sensor data record includes sensor measurements exceeding a fixed threshold. For example, the raw sensor readings might say “Temp1 = 85-degrees” with no note about what component is related to the sensor readings. Moreover, there is no context to the alert. For example, there is no statement about component location, proposed action to take, or suitable replacements. Moreover, traditional approaches provide these alerts for each instance of exceeding the fixed threshold, where persistent conditions trigger repetitive messages. In this way, traditional approaches may amass a flood of alerts, without granular hardware component context.

Additionally, traditional approaches cannot dynamically detect changes in components or firmware. The traditional approaches generally provide current readings, not change event logs. The traditional approaches may provide sensor data records at POST time, which misses later replacements or hot swaps until the next reboot. For example, firmware and component swap detection rely on a correlation with a component baseline. Without a database that snapshots hardware identifiers routinely, a post-maintenance change would appear identical unless documented. Accordingly, the traditional system cannot detect changes in the components or maintain accurate component history.

Traditional approaches are reactive, acting in response to an application, business or mission failure, and cannot identify or predict complex failure patterns such as multi-device “flapping”, “interconnectivity” or, also known as, “ghost” failures. The existing protocols provide alerts as they occur. In this way, there is no temporal correlation. The lack of temporal correlation misses detection of anomalous issues. For example, the traditional approaches fail to detect “flapping” (rapid module insert/remove or link up/down) and “ghost” failures (such as oscillating power supply status when under transient load). Accordingly, traditional approaches miss detection of impactful issues. Even with issues that are identified, the traditional approaches provide reactive responses.

Knowledge about fleets of components/machines is critical, however this knowledge is lacking across both commercial and public markets. Understanding the full picture of the infrastructure ecosystem is imperative, including the component type, location, software versions running (BIOS, firmware, operating system (OS), and kernel versions), and the overall reliability of the components, machines and software. This requires accurate and timely information that is auto-updated without human involvement. Instant observability and insight tools are the basics for gaining command and control over growing infrastructure needs. Possessing this knowledge empowers IT workforce to be strategic and enables analysis of what is and is not working so decisions can be made quickly for preventative maintenance and further improve business success.

Finally, traditional approaches do not integrate component monitoring with spare inventory management. The traditional approaches for monitoring hardware components do not track component replacement logistics. There is no integration between the traditional approaches to monitor hardware components with other systems to handle inventory management. Without integration between these approaches, the systems remain isolated. In this way, alerts cannot reliably identify inventory positions and physical location of spare parts. The traditional approaches cannot auto-decrement inventory for exact parts or trigger a reorder.

### SUMMARY

In some aspects, the techniques described herein relate to a computer-implemented method, including: receiving, from a software agent, telemetry data objects associated with operation of a hardware component, wherein the telemetry data objects include chassis position of the hardware component installed in a computing system, wherein the software agent is deployed on the computing system; performing replacement component identification for the hardware component, wherein performing the replacement component identification includes: obtaining a reliability metric associated with the hardware component based on the telemetry data objects; detecting performance decline of the hardware component based on the reliability metric; diagnosing the performance decline as a hardware failure; responsive to diagnosing the performance decline as the hardware failure, identifying a replacement component for the hardware component, wherein the replacement component is compatible with the chassis position; and obtaining a physical storage location of the replacement component; and updating a maintenance queue with the performance decline of the hardware component, the replacement component, and the chassis position.

In some aspects, the techniques described herein relate to a computer-implemented method, wherein detecting the performance decline includes performing trend analysis by pre-processing the telemetry data objects through time-series aggregation for a time window and comparing the telemetry data objects of the time window to a rolling average to identify gradual performance deterioration patterns relative to a baseline operation profile, wherein the baseline operation profile is associated with the hardware component.

In some aspects, the techniques described herein relate to a computer-implemented method, wherein detecting the performance decline includes comparing the telemetry data objects to threshold conditions based on a heuristic rule set, wherein the heuristic rule set includes count-based, vendor-specific thresholds, or type-specific thresholds.

In some aspects, the techniques described herein relate to a computer-implemented method, wherein detecting the performance decline includes performing diff analysis of string-level differences and numerical deltas of the telemetry data objects.

In some aspects, the techniques described herein relate to a computer-implemented method, wherein diagnosing the performance decline as the hardware failure includes measuring current telemetry of the hardware component against predefined threshold reliability metrics, wherein the predefined threshold reliability metrics include AFR, MTBF, or availability metric.

In some aspects, the techniques described herein relate to a computer-implemented method, wherein the telemetry data objects include component-specific identifiers, performance metrics, operational status information, slot identifications, peripheral component information, and vendor-specific labeling schemes.

In some aspects, the techniques described herein relate to a computer-implemented method, wherein the software agent corresponds to an operating system of the computing system.

In some aspects, the techniques described herein relate to a computer-implemented method, wherein receiving the telemetry data objects further includes receiving the telemetry data objects at a predetermined frequency.

In some aspects, the techniques described herein relate to a computer-implemented method, wherein receiving the telemetry data objects further includes receiving the telemetry data objects in response to a predetermined event.

In some aspects, the techniques described herein relate to a computer-implemented method, further including identifying a vendor-supplied ID of the telemetry data objects is a string including a same number.

In some aspects, the techniques described herein relate to a computer-implemented method, further including generating a unique ID to replace the vendor-supplied ID to track performance of the hardware component.

In some aspects, the techniques described herein relate to a system, including: a software agent, deployed on a computing system, configured to provide telemetry data objects associated with operation of a hardware component, wherein the hardware component is installed in the computing system; and an orchestrator engine, coupled to the software agent, wherein the orchestrator engine includes: a processor; and a non-transitory computer readable storage medium having instructions encoded thereon that, when executed by the processor, cause the processor to perform steps including: receive, from the software agent, telemetry data objects associated with operation of the hardware component, wherein the telemetry data objects include chassis position of the hardware component installed in the computing system; perform replacement component identification for the hardware component, wherein performing the replacement component identification includes: obtaining a reliability metric associated with the hardware component based on the telemetry data objects; detecting performance decline of the hardware component based on the reliability metric; diagnosing the performance decline as a hardware failure; responsive to diagnosing the performance decline as the hardware failure, identifying a replacement component for the hardware component, wherein the replacement component is compatible with the chassis position; and obtaining a physical storage location of the replacement component; and update a maintenance queue with the performance decline of the hardware component, the replacement component, and the chassis position.

In some aspects, the techniques described herein relate to a system, wherein the instructions, when executed by the processor, further include steps of performing trend analysis by pre-processing the telemetry data objects through time-series aggregation for a time window and comparing the telemetry data objects of the time window to a rolling average to identify gradual performance deterioration patterns relative to a baseline operation profile, wherein the baseline operation profile is associated with the hardware component.

In some aspects, the techniques described herein relate to a system, wherein the instructions, when executed by the processor, further include steps of comparing the telemetry data objects to threshold conditions based on a heuristic rule set, wherein the heuristic rule set includes count-based, vendor-specific thresholds, or type-specific thresholds.

In some aspects, the techniques described herein relate to a system, wherein the instructions, when executed by the processor, further include steps of performing diff analysis of string-level differences and numerical deltas of the telemetry data objects.

In some aspects, the techniques described herein relate to a system, wherein the instructions, when executed by the processor, further include steps of measuring current telemetry of the hardware component against predefined threshold reliability metrics, wherein the predefined threshold reliability metrics include AFR, MTBF, or availability metric.

In some aspects, the techniques described herein relate to a system, wherein the telemetry data objects include component-specific identifiers, performance metrics, operational status information, slot identifications, peripheral component information, and vendor-specific labeling schemes.

In some aspects, the techniques described herein relate to a system, wherein the software agent corresponds to an operating system of the computing system.

In some aspects, the techniques described herein relate to a system, wherein the instructions, when executed by the processor, further include steps of: identifying a vendor-supplied ID of the telemetry data objects is a string including a same number; and generating a unique ID to replace the vendor-supplied ID to track performance of the hardware component.

In some aspects, the techniques described herein relate to a computer program product including a non-transitory computer readable storage medium having instructions encoded thereon that, when executed by a processor, cause the processor to perform steps including: receiving, from a software agent, telemetry data objects associated with operation of a hardware component, wherein the telemetry data objects include chassis position of the hardware component installed in a computing system, wherein the software agent is deployed on the computing system; performing replacement component identification for the hardware component, wherein performing the replacement component identification includes: obtaining a reliability metric associated with the hardware component based on the telemetry data objects; detecting performance decline of the hardware component based on the reliability metric; diagnosing the performance decline as a hardware failure; responsive to diagnosing the performance decline as the hardware failure, identifying a replacement component for the hardware component, wherein the replacement component is compatible with the chassis position; and obtaining a physical storage location of the replacement component; and updating a maintenance queue with the performance decline of the hardware component, the replacement component, and the chassis position.

In some aspects, the techniques described herein relate to a computer-implemented method, including: performing predictive identification of hardware failures for a fleet of computing systems, wherein performing the predictive identification of failures includes: receiving, from software agents, telemetry data objects associated with operation of hardware components installed on the computing systems, wherein the software agents are deployed across the fleet of computing systems, wherein the telemetry data objects include chassis position of the hardware components in the fleet of computing systems; obtaining reliability metrics associated with the hardware components based on the telemetry data objects; analyzing the telemetry data objects and the reliability metrics by using a component performance algorithm, wherein the component performance algorithm compares the telemetry data objects and the reliability metrics to component-specific failure rules; and identifying a hardware component in a computing system indicative of a hardware failure based on results of the component performance algorithm; and updating a maintenance dashboard with the results of the component performance algorithm, wherein the maintenance dashboard identifies the hardware component indicative of the hardware failure, including the chassis position of the hardware component in the computing system.

In some aspects, the techniques described herein relate to a computer-implemented method, wherein the component performance algorithm computes rolling averages of the telemetry data objects and the reliability metrics to model error rate trajectories over operational intervals.

In some aspects, the techniques described herein relate to a computer-implemented method, wherein the component performance algorithm computes time-differentiated slopes of the telemetry data objects and the reliability metrics to model error rate trajectories over operational intervals.

In some aspects, the techniques described herein relate to a computer-implemented method, wherein the component performance algorithm performs curve-fitting to locate inflection points, wherein the inflection points indicate an error rate acceleration surpasses a defined threshold, wherein the defined threshold is based on historical norms.

In some aspects, the techniques described herein relate to a computer-implemented method, wherein the component-specific failure rules correspond to a type of the hardware component.

In some aspects, the techniques described herein relate to a computer-implemented method, wherein a first component-specific failure rule corresponds to a first type of hardware component and a second component-specific failure rule corresponds to a second type of hardware component different than the first type.

In some aspects, the techniques described herein relate to a computer-implemented method, wherein the component-specific failure rules include one or more of vendor-specific error codes, firmware issues, patterns of component change history, failure modes appearing as multi-device flapping count of permitted read and write cycles.

In some aspects, the techniques described herein relate to a system, including: software agents, deployed on a fleet of computing systems, wherein the software agents are configured to provide telemetry data objects associated with operation of a corresponding hardware component, wherein the corresponding hardware component is installed in the fleet of computing systems; and an orchestrator engine, coupled to the software agents, wherein the orchestrator engine includes: a processor; and a non-transitory computer readable storage medium having instructions encoded thereon that, when executed by the processor, cause the processor to perform steps including: performing predictive identification of hardware failures for the fleet of computing systems, wherein performing the predictive identification of failures includes: receiving, from the software agents, telemetry data objects, wherein the telemetry data objects include chassis position of hardware components in the fleet of computing systems; obtaining reliability metrics associated with the hardware components based on the telemetry data objects; analyzing the telemetry data objects and the reliability metrics by using a component performance algorithm, wherein the component performance algorithm compares the telemetry data objects and the reliability metrics to component-specific failure rules; and identifying a hardware component in a computing system indicative of a hardware failure based on results of the component performance algorithm; and updating a maintenance dashboard with the results of the component performance algorithm, wherein the maintenance dashboard identifies the hardware component indicative of the hardware failure, including the chassis position of the hardware component in the computing system.

In some aspects, the techniques described herein relate to a system, wherein the component performance algorithm computes rolling averages of the telemetry data objects and the reliability metrics to model error rate trajectories over operational intervals.

In some aspects, the techniques described herein relate to a system, wherein the component performance algorithm computes time-differentiated slopes of the telemetry data objects and the reliability metrics to model error rate trajectories over operational intervals.

In some aspects, the techniques described herein relate to a system, wherein the component performance algorithm performs curve-fitting to locate inflection points, wherein the inflection points indicate an error rate acceleration surpasses a defined threshold, wherein the defined threshold is based on historical norms.

In some aspects, the techniques described herein relate to a system, wherein the component-specific failure rules correspond to a type of the hardware component.

In some aspects, the techniques described herein relate to a system, wherein a first component-specific failure rule corresponds to a first type of hardware component and a second component-specific failure rule corresponds to a second type of hardware component different than the first type.

In some aspects, the techniques described herein relate to a system, wherein the component-specific failure rules include one or more of vendor--specific error codes, firmware issues, patterns of component change history, failure modes appearing as multi--device flapping count of permitted read and write cycles.

In some aspects, the techniques described herein relate to a computer program product including a non-transitory computer readable storage medium having instructions encoded thereon that, when executed by a processor, cause the processor to perform steps including: performing predictive identification of hardware failures for a fleet of computing systems, wherein performing the predictive identification of failures includes: receiving, from software agents, telemetry data objects associated with operation of hardware components installed on the computing systems, wherein the software agents are deployed across the fleet of computing systems, wherein the telemetry data objects include chassis position of the hardware components in the fleet of computing systems; obtaining reliability metrics associated with the hardware components based on the telemetry data objects; analyzing the telemetry data objects and the reliability metrics by using a component performance algorithm, wherein the component performance algorithm compares the telemetry data objects and the reliability metrics to component-specific failure rules; and identifying a hardware component in a computing system indicative of a hardware failure based on results of the component performance algorithm; and updating a maintenance dashboard with the results of the component performance algorithm, wherein the maintenance dashboard identifies the hardware component indicative of the hardware failure, including the chassis position of the hardware component in the computing system.

In some aspects, the techniques described herein relate to a non-transitory computer readable storage medium, wherein the component performance algorithm computes rolling averages of the telemetry data objects and the reliability metrics to model error rate trajectories over operational intervals.

In some aspects, the techniques described herein relate to a non-transitory computer readable storage medium, wherein the component performance algorithm computes time-differentiated slopes of the telemetry data objects and the reliability metrics to model error rate trajectories over operational intervals.

In some aspects, the techniques described herein relate to a non-transitory computer readable storage medium, wherein the component performance algorithm performs curve-fitting to locate inflection points, wherein the inflection points indicate an error rate acceleration surpasses a defined threshold, wherein the defined threshold is based on historical norms.

In some aspects, the techniques described herein relate to a non-transitory computer readable storage medium, wherein the component-specific failure rules correspond to a type of the hardware component.

In some aspects, the techniques described herein relate to a non-transitory computer readable storage medium, wherein a first component-specific failure rule corresponds to a first type of hardware component and a second component-specific failure rule corresponds to a second type of hardware component different than the first type.

### BRIEF DESCRIPTION OF THE DRAWINGS

FIGURE(FIG.) 1 illustrates an example computing environment, according to some aspects.

FIG. 2 depicts an example architecture of an orchestrator engine, according to some aspects.

FIG. 3 illustrates a computing system having multiple hardware components, according to some aspects.

FIG. 4 is a flow diagram showing operations for identifying a replacement hardware component, according to some aspects.

FIG. 5 presents a process for diagnosing a hardware performance decline and identifying a replacement component based on telemetry data and reliability metrics, according to some aspects.

FIG. 6 depicts an example user interface for executing the maintenance and replacement processes, according to some aspects.

FIG. 7 is a flow diagram showing operations for identification of hardware failures between multiple hardware components, according to some aspects.

FIG. 8 provides an example process for analyzing telemetry data from a fleet of to identify potential hardware failures and update maintenance dashboards, according to some aspects.

FIG. 9 depicts an example user interface for identifying potential hardware failures and update maintenance dashboards workflow, according to some aspects.

FIG. 10 depicts a machine diagram showing an example computing device, according to some aspects.

The figures depict various aspects for purposes of illustration only. One skilled in the art will readily recognize from the following discussion that alternative aspects of the structures and methods illustrated herein may be employed without departing from the principles described herein.

### DETAILED DESCRIPTION

The figures and the following description relate to preferred aspects by way of illustration only. It should be noted that from the following discussion, alternative aspects of the structures and methods disclosed herein will be readily recognized as viable alternatives that may be employed without departing from the principles of what is claimed.

Reference will now be made in detail to several aspects, examples of which are illustrated in the accompanying figures. It is noted that wherever practicable similar or like reference numbers may be used in the figures and may indicate similar or like functionality. The figures depict aspects of the disclosed system (or method) for purposes of illustration only. One skilled in the art will readily recognize from the following description that alternative aspects of the structures and methods illustrated herein may be employed without departing from the principles described herein.

### CONFIGURATION OVERVIEW

The disclosed orchestrator enhances overall machine reliability by automatically localizing slot-level faults within a computing chassis. Through deployment of lightweight agents on each system, the orchestrator collects granular telemetry data from hardware components (for example, slot identifiers (such as “DIMM A2” or “PCI slot 3”), performance metrics, error counters, and firmware versions). The orchestrator analyzes these telemetry data objects using diff-analysis and heuristic rule sets to isolate deviations specific to individual slots rather than issuing generalized system alerts. By correlating faults to precise physical positions, the system prevents unnecessary component swaps, reduces downtime, and provides maintenance actions that target the true failing element. This automated slot-level fault localization eliminates ambiguity inherent in conventional monitoring protocols such as IPMI or SNMP, thereby increasing diagnostic accuracy and improving machine reliability across large-scale data-center environments. The approaches, as described herein, have shown 10% increase in fleet lifespan from performance-based component refresh and up to 90% reduction in application failures due to physical infrastructure.

The aspects described herein allow for proactive hardware component management. Being proactive is the ability to fix issues before they occur, a practice known as preventative and predictive maintenance that includes capabilities like auto-remediation and rich data analytics/knowledge. This encompasses many different facets of an information technology (IT) organization, including broad IT teams of operations, incident response, procurement, application, cyber security, DevOps experts, and SRE teams.

The aspects described herein allow for preventative hardware component maintenance. Similar to how a medical healthcare provider maintains accurate records of patient health, or auto mechanics maintain health records of a vehicle, it is equally critical to maintain accurate health records of IT infrastructure. This information is often stored in the minds of administrators and/or manually typed into a ticketing system that holds tickets for all issues throughout an organization making it nearly impossible to access the data for analytics. Having data reside in tools, instead of inside IT workers minds, improves data accuracy and workforce knowledge sharing while diminishes productivity loss caused by workforce turnover and transitions. Accurate and intelligent curated analytics will dramatically shorten the time it takes to identify and root-cause flapping or interconnectivity issues that would otherwise go unnoticed, causing erratic application and network behavior. This knowledge enables workers to easily compare similar issues and quickly learn how they were previously solved, saving significant time and minimizing the introduction of human failures; some of the most difficult issues to solve. For example, machines can experience repetitive issues where a component appears to be dead, is replaced, and the replacement component works for some time then is deemed failed, and is replaced, and the issue repeats over and over. Without having analytics that point to a bad slot, administrators will continue wasting time and money on something that is not fixable.

Another example of gaining command and control knowledge for preventative maintenance is to have detailed fleet knowledge for intelligent procurement. Understanding fleet-wide reliability analysis and metrics on systems and components allows IT procurement teams to buy infrastructure that is proven to be highly reliable. This lessens performance loss, future failures, and impact to application service level agreements (SLAs). Insight into the reliability metrics of component fleet is critical as it is highly unlikely that component vendors have the same annual failure rate (AFR). If it is understood that one DIMM vendor model is failing at twice the rate of other DIMM vendors then proactive measures can be taken to discontinue procuring machines with the less reliable parts in it. For components containing firmware (firmware, HDDs, SSDs, NICs, etc.), intelligent data analytics tools might show that firmware version “A” had an 8% AFR while firmware version “B” had a 2% AFR. Armed with this knowledge, two preventative maintenance actions can be taken: 1) component fleet needs to be upgraded from the “A” firmware to the proven higher reliable “B” version and 2) procurement teams become empowered to leverage data analytics regarding their environments to implement changes with suppliers to prevent failures and improve application uptime. Intelligent fleet analytics enables preventative maintenance and unleashes cost savings through operational and asset efficiency gains.

Systems described herein perform predictive maintenance for hardware components of a computing system. The system performs predictive maintenance by deploying lightweight, OS-specific agents to a computing system. In some cases, there is one agent per computing system. The lightweight, OS-specific agents obtain telemetry data objects associated with a hardware component of the computing system. The telemetry data objects include granular data associated with the hardware component. The agents provide the telemetry data objects to a backend orchestrator.

The orchestrator analyzes the telemetry data objects to determine a health status of the hardware components. The backend orchestrator parses, cleans, and normalizes the telemetry data objects. The orchestrator identifies invalid data of the telemetry data objects. The orchestrator replaces the invalid data, performs historical diff analysis, and applies heuristic rule sets to identify predicted failures within a defined predictive window. The workflow may pinpoint the hardware component at a physical slot level. The orchestrator matches the failing part to compatible spares using facility-specific inventory metadata. The orchestrator generates automated ticketing and repair workflow. The orchestrator auto-validates repairs before ticket closure (for example, by performing diff analysis). Because of the continuous and automated monitoring of the hardware components, the orchestrator is able to detect and bucketize complex failure patterns (such as flapping, interconnectivity, or ghost failures) for root-cause analysis and targeted resolution.

### EXAMPLE SYSTEM OVERVIEW

FIG. 1 is a block diagram that illustrates a predictive maintenance system environment 100, in accordance with an aspect. The system environment 100 includes an orchestrator 110, a computing system 120, an inventory system 130, a client device 140, and a data store 150. The entities and components in the system environment 100 communicate with each other through a network 160.

In various aspects, the system environment 100 includes fewer or additional components. In some aspects, the system environment 100 also includes different components. While each of the components in the system environment 100 is described in a singular form, the system environment 100 may include one or more of each of the components. For example, in many situations, the orchestrator 110 may monitor one or more computing systems for a computer infrastructure. Different client devices 140 may also access the orchestrator 110 simultaneously (for example, to monitor performance of the computing system 120).

### Orchestrator

The orchestrator 110 may instruct deployment of the agent 124 to the computing system 120, process telemetry data objects, and assess predictive maintenance for the hardware components 122. In some cases, the orchestrator 110 may deploy the agent 124 to the computing system 120. The orchestrator 110 may determine an operating system (OS) of the computing system 120. A type of the agent 124 selected may correspond to the OS of the computing system 120. For example, the orchestrator 110 may determine the OS of the computing system 120 is WINDOWS and select the agent 124 to deploy to the computing system 120 particular to WINDOWS.

The orchestrator 110 may process the telemetry data objects from the agent 124 (for example, via the network 160) to perform predictive maintenance for the hardware components 122. The telemetry data objects may include slot and/or bay location, vendor, model, serial number (or generated unique ID), firmware version, BIOS version, OS version, kernel version, capacity, speed, operational metrics, error metrics, and/or the like. The telemetry data objects describe how the hardware component 122 operates, where the hardware component 122 is, etc. In aggregate, the telemetry data objects provide real-time information about the state of the hardware component 122. In some cases, the orchestrator 110 may update the telemetry data objects. For example, the orchestrator 110 may identify and replace invalid (or missing) identifiers of the telemetry data objects. In this way, the orchestrator may generate unique IDs for the hardware component 122 with invalid (or missing) identifiers.

In some cases, the orchestrator 110 performs predictive maintenance by applying the telemetry data objects to various algorithms. For example, the algorithms may include a health diagnostic algorithm, a predictive failure algorithm (heuristics-based rule sets and trend detection), machine learning algorithms, and/or the like.

The orchestrator 110 may be implemented as a physical on-premises server located in a data center. In some cases, the orchestrator 110 may be a cluster of servers providing high-availability orchestration; a virtual machine deployed within a private or public cloud environment; a containerized microservice deployment (for example, DOCKER/KUBERNETES) distributed across multiple compute instances. The orchestrator 110 may operate as a single centralized instance serving multiple customer sites, or as multiple edge instances operating autonomously with periodic synchronization to a global repository. In some cases, the orchestrator 110 may include storage and processing resources. For example, the orchestrator 110 may include direct-attached storage in a physical appliance; network-attached storage (NAS) or storage-area network (SAN); cloud-based object storage for scalability; and/or the like. In some examples, the orchestrator 110 may execute instructions as part of a software-as-a-service (SaaS) offering, where functions of the orchestrator 110 may be delivered to client devices 140 over the Internet.

### Computing System

The computing system 120 may provide a physical installation location of the hardware components 122 (such as a chassis of a rack-mounted server in a data center) and computing resources used to execute the agent 124 to capture telemetry data objects (such as a processor executing a server-level OS). The computing system 120 could be a rack-mounted physical server in an enterprise or data center environment. In some cases, the computing system 120 may be a desktop workstation or laptop. The computing system 120 may be a virtual machine or virtualized host environment (VMWARE ESX, KVM, HYPER-V), in which case the agent 124 executes within the VM’s OS and collects telemetry data objects. In some cases, the computing system 120 may be a cloud-based instance (IaaS VM) where the agent 124 is permitted to run and query virtualized hardware-level metrics.

The computing system 120 may execute an OS. For example, the computing system 120 may execute WINDOWS, LINUX, VMWARE, and/or the like. Because of this, the computing system 120 may execute the agent 124 according to the OS of the computing system 120.

In some examples, the computing system 120 may include various hardware configurations. For example, the computing system 120 may include enterprise-grade multi-CPU, multi-DIMM, multi-NIC systems to resource-constrained IoT-class or edge-computing devices like INTEL NUCs or RASPBERRY PI-class systems.

The hardware components 122 may include physical and/or virtual components associated with hardware located in the computing system to provide telemetry data objects to the agent 124. The hardware components 122 may receive an instruction from the agent 124 to provide the telemetry data objects.

In some examples, the hardware components 122 may include CPUs, memory modules (DIMMs), storage devices (HDD/SSD), network interface cards (NICs), power supplies, fans, and peripheral devices housed within the monitored computing system 120. The hardware components 122 may correspond to a chassis position (such as a physical slot and/or bay location within the chassis (or motherboard)) of the computing system 120. For example, the installation of the hardware components 122 may follow vendor-specific labeling (for example, DIMM slot D6, PCI slot 3).

The hardware components 122 generate telemetry data objects collected by the agent 124 executing on the computing system 120.

In some examples, the hardware component 122 may include various software and/or firmware. For examples, the firmware may differ by vendor and model. Because of the differing firmware, the hardware component 122 may provide vendor-specific error codes (which may be used for predicting failure analysis).

The hardware components 122 may be internal (such as on-board, slot-mounted, and/or the like) or external (for example, USB devices, hot-swappable drives, and/or the like). In some cases, the hardware components 122 may be virtualized (for example, cloud or VM environments), where telemetry data objects reflect virtualized hardware states exposed to the OS rather than bare-metal readings.

The agent 124 may obtain the telemetry data objects from the hardware components 122 and provide the telemetry data objects to the orchestrator 110. The agent 124 may perform telemetry data object collection both on a periodic cadence and on event triggers. The event triggers may be hardware removal/insertion, firmware change, OS log event, and/or the like.

The agent 124 may be a lightweight, OS-specific agent. A lightweight agent may include functions (such as instructions executed local to the computing system 120) to operate with reduced resource consumption and fast deployment (such as deployment in 10–12 seconds per machine). In some cases, the agent 124 may include multiple agents deployed on the computing system 120. For example, there may be one agent per hardware component 122 on the computing system 120.

The agent 124 may operate bidirectionally. For example, the agent 124 may deliver telemetry data objects to the orchestrator 110 for observability, reliability calculations, and predictive failure analysis. The agent 124 may receive data and instructions from the orchestrator 110. For example, the agent may execute backend-pushed packages for self-updating, firmware and/or kernel changes, security actions (for example, isolating compromised machines), and/or the like.

In some cases, the agent 124 may correspond to OSs or classes of OS associated with the computing system 120 and/or hardware components 122. In some examples, the agent 124 may be an agent for WINDOWS builds (server, laptop, desktop, and/or the like); an agent for LINUX distributions; an agent for VMWARE hosts.

For push installations, in some cases, the computing system 120 may receive an instruction from the orchestrator 110 to deploy the agent 124 (such as a push installation deployment). In this way, the computing system 120 may deploy the agent 124 with root/admin credentials provided by the orchestrator 110.

For pull installations, the computing system 120 may interact with a URL, which causes the computing system 120 to deploy the agent 124 (such as a pull installation deployment).

For pre-installation, in some cases, the computing system 120 may deploy the agent 124 according to boot images for automatic activation on new systems (such as pre-installation deployment). In some cases, the agent 124 may be container-based agents, agents with extended local processing for edge analytics, agents integrated into hypervisor layers to monitor virtualized hardware states rather than bare-metal components.

### Inventory System

The inventory system 130 maintains a comprehensive, real-time database of spare hardware components across a physical storage location. The inventory system 130 may store location-aware metadata for spares. For example, the metadata may include bin numbers, rack positions, data center identification, and quantities on hand. The inventory system 130 may provide search functions to locate an inventory item system-wide based on vendor, model, location, or other compatibility criteria.

The inventory system 130 may be implemented as a dedicated backend database physically co-located with the orchestrator, a cloud-based inventory management service accessible via secure API, a hybrid system with local facility databases synchronized to a central repository, and/or the like.

The inventory system 130 may interact with the orchestrator 110 (and/or other components of the system environment 100). For example, the inventory system 130 may provide for manual entry of new spares via a web-based GUI; automated intake using barcode or QR code scanning tied to part metadata; integration with third-party ERP or asset-tracking systems for initial data population or ongoing synchronization; and/or the like.

In some cases, the inventory system 130 may store data identifying spare location granularity from coarse building-level identifiers to bin-level mapping (for example, with GPS or RFID tagging).

In some examples, the inventory system 130 may be within a customer’s on-premises infrastructure. In other examples, the inventory system 130 may be hosted by a managed service provider. In some cases, the inventory system 130 may store physical spare asset tracking but also virtualized or pre-provisioned components (for example, virtual NICs, licenses) in software-defined infrastructure contexts. Alternative configurations may allow multi-tenant inventory partitioning, where a single system tracks spares for multiple independent organizations or departments, each with their own access controls.

### Client Device

The client device 140 is a computing device that belongs to a client of the orchestrator 110. A client uses the client device 140 to communicate with the orchestrator 110 and performs predictive maintenance-related tasks such as identifying hardware components that indicate a hardware failure for replacement and performing replacement of the hardware components based on assessment from the orchestrator 110. The user of the client device 140 may be an engineer, IT personnel, manager, or a general employee of an organization. While in this disclosure a client is often described as an organization, a client may also be a natural person or a robotic agent. A client may be referred to an organization or its representative such as its employee. A client device 140 includes one or more applications 142 and interfaces 144 that may display visual elements of the applications 142. The client device 140 may be any computing device. Examples of such client devices 140 include personal computers (PC), desktop computers, laptop computers, tablets (for example, iPads), smartphones, wearable electronic devices such as smartwatches, or any other suitable electronic devices.

The application 142 is a software application that operates at the client device 140. In one aspect, the application 142 is published by the party that operates the orchestrator 110 to allow clients to communicate with the orchestrator 110. For example, the application 142 may be part of a SaaS platform of the orchestrator 110 that allows a client to review hardware component performance across a fleet of computing systems. In various aspects, the application 142 may be of different types. In one aspect, the application 142 is a web application that runs on JavaScript and other backend algorithms. In the case of a web application, the application 142 cooperates with a web browser to render a front-end interface 144. In another aspect, the application 142 is a mobile application. For example, the mobile application may run on Swift for iOS and other APPLE OSs or on Java or another suitable language for ANDROID systems. In yet another aspect, the application 142 may be a software program that operates on a desktop computer that runs on an OS such as LINUX, MICROSOFT WINDOWS, MAC OS, or CHROME OS.

An interface 144 is a suitable interface for a client to interact with the orchestrator 110. The client may communicate with the application 142 and the orchestrator 110 through the interface 144. The interface 144 may take different forms. In one aspect, the interface 144 may be a web browser such as CHROME, FIREFOX, SAFARI, INTERNET EXPLORER, EDGE, etc. and the application 142 may be a web application that is run by the web browser. In one aspect, the interface 144 is part of the application 142. For example, the interface 144 may be the front-end component of a mobile application or a desktop application. In one aspect, the interface 144 also is a graphical user interface (GUI) which includes graphical elements and user-friendly control elements. In one aspect, the interface 144 does not include graphical elements but communicates with the orchestrator 110 via other suitable ways such as application program interfaces (APIs), which may include conventional APIs and other related mechanisms such as webhooks.

In some aspects, the client device 140 and the orchestrator 110 belong to the same domain. For example, a company client can request the orchestrator 110 to present performance data of a fleet of computing systems for the domain. A domain refers to an environment in which a system operates and/or an environment for a group of units and individuals to use common domain knowledge to organize activities, information and entities related to the domain in a specific way. An example of a domain is an organization, such as a business, an institute, or a subpart thereof and the data within it. A domain can be associated with a specific domain knowledge ontology, which could include representations, naming, definitions of categories, properties, logics, and relationships among various concepts, data, transactions, and entities that are related to the domain. The boundary of a domain may not completely overlap with the boundary of an organization. For example, a domain may be a subsidiary of a company. Various divisions or departments of the organization may have their own definitions, internal procedures, tasks, and entities. In other situations, multiple organizations may share the same domain.

### Data Store

The data store 150 includes one or more computing devices that include memory or other storage media for storing various files and data of the orchestrator 110. The data stored in the data store 150 may include telemetry data objects, identifiers for computing systems, hardware components, performance rule sets, and/or the like.

In various aspects, the data store 150 may take different forms. In one aspect, the data store 150 is part of the orchestrator 110. For example, the data store 150 is part of the local storage (for example, hard drive, memory card, data server room) of the orchestrator 110. In some aspects, the data store 150 is a network-based storage server (for example, a cloud server). The data store 150 may be a third-party storage system such as AMAZON AWS, DROPBOX, RACKSPACE CLOUD FILES, AZURE BLOB STORAGE, GOOGLE CLOUD STORAGE, etc. The data in the data store 150 may be structured in different database formats such as a relational database using the structured query language (SQL) or other data structures such as a non-relational format, a key-value store, a graph structure, a linked list, an object storage, a resource description framework (RDF), etc. In one aspect, the data store 150 uses various data structures mentioned above.

Various servers in this disclosure may take different forms. In one aspect, a server is a computer that executes code instructions to perform various processes described in this disclosure. In another aspect, a server is a pool of computing devices that may be located at the same geographical location (for example, a server room) or be distributed geographically (for example, cloud computing, distributed computing, or in a virtual server network). In one aspect, a server includes one or more virtualization instances such as a container, a virtual machine, a virtual private server, a virtual kernel, or another suitable virtualization instance.

### Network

The network 160 provides connections to the components of the system environment 100 through one or more sub-networks, which may include any combination of local area and/or wide area networks, using both wired and/or wireless communication systems. In one aspect, a network 160 uses standard communications technologies and/or protocols. For example, a network 160 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 160 include multiprotocol label switching (MPLS), transmission control protocol/Internet protocol (TCP/IP), hypertext transport protocol (HTTP and/or HTTPS), simple mail transfer protocol (SMTP), and file transfer protocol (FTP). Data exchanged over a network 160 may be represented using any suitable format, such as hypertext markup language (HTML), extensible markup language (XML), JavaScript object notation (JSON), and structured query language (SQL). In some aspects, some of the communication links of a network 160 may be encrypted using any suitable technique or techniques such as secure sockets layer (SSL), transport layer security (TLS), virtual private networks (VPNs), Internet Protocol security (IPsec), etc. The network 160 also includes links and packet switching networks such as the Internet. In some aspects, a data store belongs to part of the internal computing system of a server (for example, the data store 150 may be part of the orchestrator 110). In such cases, the network 160 may be a local network that enables the server to communicate with the rest of the components.

### ORCHESTRATOR COMPONENTS

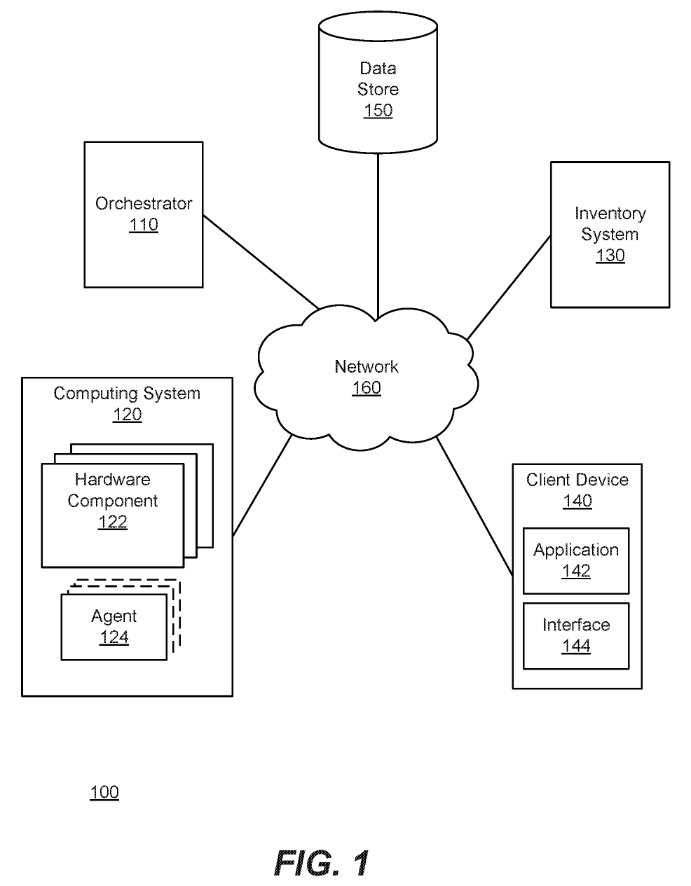

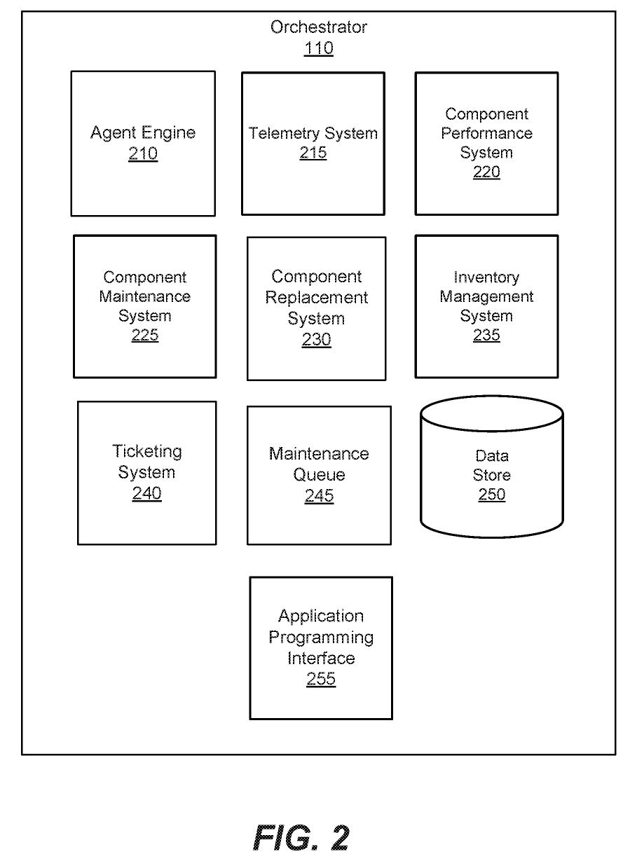

FIG. 2 is a block diagram illustrating components of an orchestrator 110, in accordance with an aspect. The orchestrator 110 includes an agent engine 210, a telemetry system 215, a component performance system 220, a component maintenance system 225, a component replacement system 230, an inventory management system 235, a ticketing system 240, a maintenance queue 245, a data store 250, and an application programming interface 255. In various aspects, the orchestrator 110 may include fewer or additional components. The functions of various components may be distributed in a different manner than described below. Moreover, while each of the components in FIG. 2 may be described in a singular form, the components may present in plurality. The components may take the form of a combination of software and hardware, such as software (for example, program code comprised of instructions) that is stored on memory and executable by a processing system (for example, one or more processors).

### Agent Engine

The agent engine 210 may deploy an agent 124 to a computing system 120 and receive telemetry data objects associated with a hardware component 122 from the agent 124. In one aspect, deploying an agent refers to the installation and activation of a software module on the computing system 120 so that the module can monitor the hardware components 122, collect telemetry data objects, and communicate with the orchestrator 110. The agent engine 210 may store scripts (or compiled code) designed to execute the agent 124 on various OSs such as LINUX, WINDOWS, or VMWARE environments. In response to being deployed, the agent 124 operates as a background process on the computing system 120 that periodically (and/or asynchronously) gathers machine configuration, component health, and telemetry data objects. The data is formatted (for example, in a JSON structure) and securely transmitted, such as via HTTPS or SSL-encrypted channels, to the agent engine 210 for analysis and control functions.

In some examples, the agent engine 210 may deploy the agent 124 using multiple deployment mechanisms. In a push-based deployment, the agent engine 210 connects to the computing system 120 (for example, using administrator credentials (for example, root or sudo access)) and remotely installs the agent package. The agent 124 is then automatically registered to the backend and begins reporting without user intervention. In a pull-based deployment, the computing system 120 itself initiates contact with the agent engine 210 (such as by accessing a designated URL) whereupon the agent engine 210 provides and installs the agent 124. In a pre-installation (pre-install) method, the agent 124 is embedded into a system image (or provisioning framework, such as a boot image) associated with the computing system 120. In this way, the computing system 120 may automatically include and activate the agent 124 upon boot. Across the modes, an agent instance uniquely registers with the agent engine 210, verifies version, and may update itself when a newer package is available. This allows consistent and scalable deployment of agents across heterogeneous infrastructure environments

The agent engine 210 may manage agent binary packages, OS detection metadata, deployment scripts (and/or configurations), lifecycle status logs (such as installed, active, updated, removed), and/or the like. The agent engine 210 may define reporting intervals and event-triggered execution. In this way, the agent 124 may report the telemetry data objects periodically and/or asynchronously (for example, when value changes, log events, or hardware changes occur).

The agent engine 210 may perform bidirectional communication with the agent 124 deployed on the computing system 120. For example, the agent engine 210 may send instructions to the agent 124. For example, the instructions may be commands and/or packages for self-update and future remediation actions (for example, firmware/kernel upgrades, security isolation). The agent engine 210 may establish a secure SSL/HTTPS channel with the computing system 120 and initialize the agent 124 on the computing system 120.

The agent engine 210 may store mapping between the agent 124 and associated hardware component(s). The agent engine 210 may manage agent installation, detects installation success/failure, and queues retry operations.

The agent engine 210 may deploy the agent 124 by executing compiled binaries (WINDOWS) or interpreted shell/PYTHON scripts (LINUX/VMWARE). In some cases, the agent engine 210 may cause execution of the agent 124 as containerized components for KUBERNETES/DOCKER environments.

In some cases, the agent engine 210 may cause execution of the agent 124 on bare-metal servers, virtual machines, cloud instances, edge/IoT devices with OS support, and/or the like. In some examples, the agent engine 210 may adjust reporting frequency of the agent 124. For example, the agent engine 210 may instruct the agent 124 to provide telemetry data objects more frequent on anomaly detection, less frequent on stable operation, or driven by external schedules/policies, and/or the like.

In some cases, the agent engine 210 may interact with the agent 124 in an off-line environment. In this way, the agent engine 210 may store collected telemetry data objects (for example, in the data store 250) in response to disconnection and automatically sync upon reconnect.

### Telemetry System

The telemetry system 215 receives, processes, and organizes telemetry data objects transmitted by the agent 124. The telemetry system 215 may receive the telemetry data objects from the agent 124, for example, via secure HTTPS/SSL communications. The telemetry system 215 may perform data cleaning. For example, the telemetry system 215 may detect invalid (and/or missing) field (for example, vendor serial numbers set to “00000” or another invalid field, such as “12345”). Responsive to detecting the invalid field, the telemetry system 215 may replace the field with generated unique string.

The telemetry system 215 may update mapping associations between the telemetry data object with slot-level positional information of the hardware component 122 for precise location tracking. For example, the slot-level positional information may include vendor silkscreen labels, such as DIMM A2, CPU0, PCI slot 3.

The telemetry system 215 may provide the telemetry data object to downstream systems, such as the component performance system 220 for reliability and trend metrics; the component maintenance system 225 for health diagnostics and predictive failure analysis (such as, a 28-day window); the component replacement system 230 for compatibility checks and spare part matching; and/or the like.

The telemetry system 215 may receive the telemetry data object in JSON, XML, or other serialization formats. The telemetry system 215 may receive (and/or send) the telemetry data object over VPN tunnels, private network interconnects, or encrypted message-queue systems.

The telemetry system 215 may track change deltas to reduce storage overhead, or store complete periodic snapshots for full forensic history. The telemetry system 215 may integrate with the inventory system 130 to auto-update inventory without manual entry.

### Component Performance System

The component performance system 220 evaluates performance of the hardware component 122 of the computing system 120 based on the telemetry data objects. The component performance system identifies a performance decline of the hardware component by comparing the hardware performance information of the telemetry data objects.

The component performance system 220 evaluates the operational performance of one or more hardware components 122 of a computing system 120 based on telemetry data objects received from the agent 124. In one aspect, the component performance system 220 extracts hardware performance information (such as temperature readings, throughput rates, latency metrics, and error counters) from the telemetry data objects stored in a data store 250. The component performance system 220 normalizes these metrics into a unified data schema and applies a diff analysis process that compares successive telemetry data objects to determine variations. For example, variations in specific string or numerical elements representing measured parameters. To execute the diff analysis, the component performance system 220 may compute deltas or percentage changes across time-indexed records, in some cases, using a rolling average or weighted comparison model to mitigate transient anomalies. In this way, the component performance system 220 operates as an analytical module that converts low-level telemetry data into actionable performance intelligence within the overall orchestration environment.

In certain aspects, the component performance system 220 may execute as a standalone analytics service, a microservice container, or a functional module integrated within a distributed orchestration framework. For instance, when deployed as a cloud-hosted microservice, the component performance system 220 may use stream-processing architectures such as event-driven message queues or publish-subscribe protocols (for example, MQTT, AMQP, or Kafka messaging) to receive telemetry data objects in near real time. Alternatively, when embedded in an on-premises controller, the system 220 may read telemetry data objects from local storage or shared memory buffers associated with the computing system 120 and perform the diff analysis using locally cached datasets to minimize network latency.

The data generated by the component performance system 220 may be implemented in various formats, such as a relational database table, serialized JSON record, or graph model to represent dependencies among components. In further variations, the diff analysis logic may employ string comparison algorithms (for example, hash-based comparison, or line-by-line diffing) or numeric delta computations depending on the data type of each telemetry field.

In some cases, the component performance system 220 may identify performance of the hardware component 122 according to vendor-specific diagnostic codes to avoid false positives. For example, the vendor-specific diagnostic codes may include SMART codes for HDD/SSD.

In some cases, the component performance system 220 may track trends over time to detect degradation patterns. For example, the degradation patterns may include knee-in-the-curve error rate growth, nearing SSD read/write cycle thresholds, and/or the like.

The component performance system 220 may identify the hardware component 122 with reliability deviating from a target specification (for example, 15–18% AFR as compared to a target AFR of 1% from the component specifications).

### Component Maintenance System

The component maintenance system 225 may identify, diagnose, and initiate remedial actions for health issues of the hardware component 122 in the computing system 120. The component maintenance system 225 may analyze the telemetry data objects by using a performance algorithm.

In one aspect, the performance algorithm executed by the component maintenance system 225 refers to a sequence of data-analysis operations configured to evaluate telemetry data objects against predefined or dynamically learned reliability parameters for each component type. The algorithm may begin by acquiring raw telemetry attributes—such as sensor readings, error-count logs, throughput values, and vendor-specific diagnostic codes—from the data store 250. These data fields may first be normalized and aligned into time-ordered sequences to permit statistical comparison across multiple observation intervals. When the metrics derived from the incoming telemetry data deviate from those thresholds beyond a configurable tolerance, the algorithm marks an anomaly event or a degradation pattern.

The performance algorithm may combine deterministic rule evaluation with statistical and predictive modeling techniques. For instance, the performance algorithm may compute rolling averages or exponential moving means of selected telemetry parameters to identify directional changes in performance, apply diff or delta analysis between successive telemetry samples to quantify the rate of degradation, and use curve-fitting or trend-projection functions to forecast near-term failure probability within a specified window (for example, a 28-day risk horizon). The algorithm may further assign correlation weights to multi-device patterns (such as simultaneous temperature spikes or synchronized throughput drops) to detect systemic issues such as “flapping” or ghost failures. The output of the algorithm is a structured maintenance data record that links identified conditions to component identifiers and physical slot mapping, enabling the orchestrator 110 to queue correct maintenance actions. The performance algorithm may include machine learning models. The machine learning models may include one or more of a classifier model, a neural network model, a foundational model.

The performance algorithm compares the telemetry data objects to component-specific failure rules. The component-specific failure rules may include a MTBF, AFR, and/or the like. The MTBF may be a total aggregated runtime divided by a number of failures. The AFR may be a percentage of components failing in a rolling 12-month period (or another time frame).

In some implementations, the component maintenance system 225 may be instantiated as a dedicated analytic microservice, as a plug-in module within the orchestrator 110, or as a distributed function operating on multiple virtual machines to scale with large telemetry datasets. In a cloud-deployed configuration, the component maintenance system 225 may ingest telemetry streams via asynchronous message brokers, apply the performance algorithm using batch or stream processing engines, and persist calculated MTBF or AFR values to a centralized data store 250. In an on-device configuration, the system 225 may operate as part of a local maintenance agent reading diagnostic registers directly from the hardware controller interfaces and performing rule evaluation with locally cached parameter thresholds.

Alternative algorithms may include regression-based degradation modeling, clustering of error-rate sequences, or weighted scoring of vendor-specific diagnostics to refine near-term failure forecasts. Across these implementations, the component maintenance system 225 remains operable to analyze performance and diagnostic telemetry in accordance with component-specific reliability rules and to output structured maintenance indicators used by other orchestration subsystems to plan, schedule, or automate hardware servicing operations.

### Component Replacement System

The component replacement system 230 automates identification of compatible replacement hardware parts for components detected as degraded or failing by the component maintenance system 225. In one aspect, the component replacement system 230 receives information such as vendor and model identifiers, firmware versions, BIOS, OS, kernel versions, capacity and speed parameters, unique identification numbers, and physical slot locations. The component replacement system 230 may parse the information and construct a query to the inventory management system 235 (which may store part-number mappings, system-configuration data, and facility-specific inventory details).

The component replacement system 230 evaluates each candidate spare part against a compatibility ruleset maintained in a backend repository, where rules define conditions such as supported machine types, slot geometries, interface standards, and firmware or BIOS dependency matching.

In some examples, the compatibility ruleset may be implemented as a dynamic knowledge base that can be updated by machine-learning models trained on historical replacement outcomes, allowing adaptation to new component models or firmware dependencies. The component replacement system 230 may operate with either centralized or distributed inventory data sources, where facility-specific metadata is synchronized through periodic replication or cloud storage updates.

In response to identifying a compatible spare, the component replacement system 230 retrieves location metadata (such as bin numbers, rack positions, and data-center codes) to generate precise logistics instructions. The replacement instructions, including component and bin identifiers, are transferred to the ticket system 240, which issues prescriptive maintenance guidance such as “replace the DIMM in slot D6 with the part from bin B7,” and later updates the post-repair validation record once the replacement action is confirmed. Through these coordinated operations, the component replacement system 230 functions as an automated decision engine that allows accurate, compatible, and auditable component substitutions across the computing infrastructure managed by the orchestrator 110.

In some aspects, the component replacement system 230 may be deployed as an independent microservice within a containerized orchestration environment or integrated directly into the orchestrator 110 backend to execute rule-matching logic locally. The inventory correlation may occur through RESTful or GraphQL APIs, database stored-procedure calls, or message-queue interactions with the inventory management system 235, depending on network topology and latency requirements.

Post-repair validation may be performed automatically by invoking diagnostic routines through the component performance system 220 or through the ticket system 240.

In further variations, the component replacement system 230 may utilize graph relationships to represent inter-component dependencies, enabling algorithmic selection of optimal replacements when multiple parts influence system operation. Across these implementations, the component replacement system 230 remains operable to evaluate replacement eligibility, select compatible spares, and orchestrate maintenance workflows, thereby maintaining continuous reliability and hardware integrity within the computing environment.

### Inventory Management System

The inventory management system 235 maintains a real-time, facility-aware repository of spare hardware components and related logistics data to support predictive maintenance and automated repair workflows coordinated by the orchestrator 110. In one aspect, the inventory management system 235 receives replacement requests from the component replacement system 230 that include component metadata, such as vendor and model information, part numbers, slot locations, and compatibility rule identifiers.

In response to receiving a request, the inventory management system 235 parses the metadata and queries internal inventory records to identify spare parts matching the required parameters. The inventory management system 235 retrieves location descriptors such as facility name, rack position, and bin number and validates the availability status against current inventory counts to identify a compatible spare that is physically accessible.

The inventory management system 235 may automatically decrement spare counts in response to installation or replacement events detected by agents or confirmed through telemetry from the computing system 120, thus maintaining synchronization between component deployment and spare pool totals.

The inventory management system 235 may also interface with the ticket system 240 to inject location metadata into prescriptive repair tickets, generating actionable logistics instructions for technicians. In this manner, the inventory management system 235 provides a dynamic, data-driven control layer that aligns component replacement supply with hardware maintenance demand across distributed facilities.

In certain aspects, the inventory management system 235 may operate as a centralized database service hosted on a cloud platform, as a distributed microservice cluster co-located with regional data centers, or as a hybrid system combining local caching and global synchronization. In a cloud-managed configuration, facility inventories may be stored in regional partitions with replication protocols (for example, asynchronous REST transactions or SQL replication) ensuring near-real-time updates.

### Ticket System

The ticket system 240 manages the lifecycle of hardware repair and service tickets generated in response to issues detected by the orchestrator 110. The ticketing system 240 receives issue identification data from the component maintenance system 225, including the affected component’s identifiers, physical slot location, failure mode, and predictive failure confidence score. Using these inputs, the ticket system 240 constructs a structured maintenance record that contains prescriptive repair instructions such as machine rack or chassis location, vendor and model details, the unique serial number of the failed part, and a list of supported replacement part numbers and facility bin identifiers supplied by the inventory management system 235. The ticketing system 240 populates these details into a ticketing data structure and, through bidirectional data exchange via the application programming interface 255, integrates with external ticketing platforms to post new tickets or update existing ones in real time.

In response to a repair action being executed, the ticket system 240 analyzes post-repair telemetry data and automatically validates that a new component has appeared in the correct slot, that its identifiers match an approved replacement model, and that operational readings indicate normal functioning. A successful validation triggers automatic closure of the ticket, whereas mismatches or non-operative states re-open the record until resolution is confirmed. Through these coordinated operations, the ticket system 240 provides an automated bridge between predictive failure detection and verified physical repair, maintaining accurate maintenance traceability throughout the orchestrated environment. In some cases, ticket closure verification may employ diff-based analysis workflows similar to those used by the component performance system 220, or may invoke diagnostic modules that compare newly installed component metadata against compatibility lists maintained by the component replacement system 230. The ticket schema may be represented in relational tables, serialized JSON objects, or graph-linked structures to express dependencies among components and facilities.

The ticket system 240 may be deployed in different configurations depending on system scale and integration requirements. In a distributed implementation, the ticket system 240 may run as a microservice cluster that interfaces with multiple external platforms through asynchronous message queues or HTTPS REST transactions to accommodate varied data center networks. In a cloud-based implementation, tickets may be maintained in a centralized database with webhook or API callbacks to third-party systems such as enterprise resource planning modules or operational dashboards. Across these implementations, the ticket system 240 remains operable to generate service tickets, distribute prescriptive repair information, and confirm closure upon repair validation, ensuring comprehensive maintenance automation and audit continuity within the orchestrator 110 computing environment.

### Maintenance Queue

The maintenance queue 245 functions as the orchestrator 110 internal workflow staging area for pending, scheduled, and prioritized maintenance operations. The maintenance queue 245 receives maintenance task entries from the component maintenance system 225, which reports predictive failure alerts and diagnostic events, and from the ticket system 240, which provides corresponding repair instructions and task identifiers.

In response to ingestion, the maintenance queue 245 organizes the incoming tasks according to predefined criteria such as severity ranking, service-level-agreement (SLA) deadlines, and the operational criticality of the affected hardware components.

The maintenance queue 245 can be implemented in a variety of forms depending on infrastructure scale and performance requirements. In one arrangement, the maintenance queue 245 may execute as a persistent queue service hosted on a centralized orchestration server, while in other configurations it operates as a distributed microservice or message-stream subsystem built on queuing technologies such as Kafka, RabbitMQ, or cloud-native service buses.

### Data Store

In some aspects, the data store 250 is a database that stores various information with respect to settings provided by customers of the orchestrator 110. The data stored may include telemetry data objects, data structures corresponding to the telemetry data objects, heuristic rule sets, and various policies associated with operations specified by the orchestrator 110.

### Application Programming Interface

In some aspects, an application programming interface 255 allows a party to communicate with and access the functionalities of the orchestrator 110 directly through a programming language. For example, the orchestrator 110 may communicate with the computing system 120 and deploy the agent 124. An API notification, such as a webhook notification, may include a header and a payload. The payload may be in the format of key-value pairs that are in the format of JSON, XML, YAML, CSV, or another suitable format.

### EXAMPLE COMPUTING SYSTEM

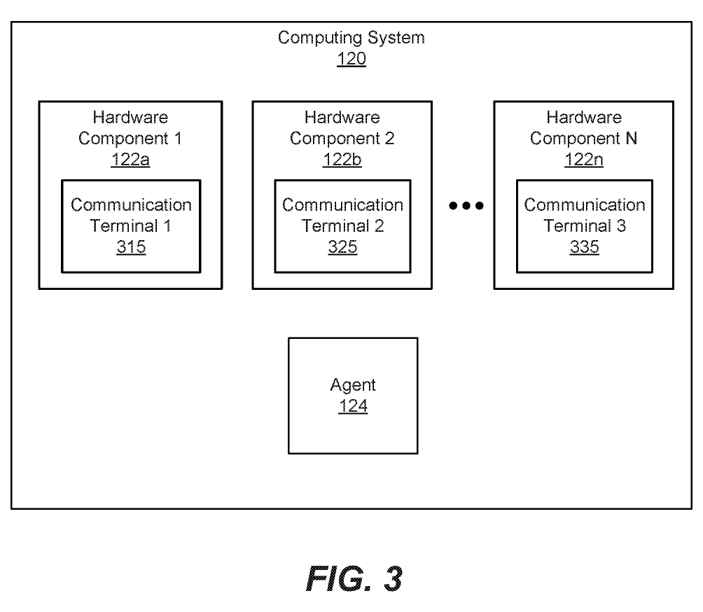

FIG. 3 illustrates the computing system 120 that includes multiple hardware components 122a, 122b, 122n and communication terminals 315, 325, 335, according to an example aspect. The computing system 120 facilitates interactions between the agent 124 and the hardware components 122a, 122b, 122n through associated communication terminals 315, 325, 335 to enable coordinated operations among system elements. FIG. 3 includes a computing system 120, an agent 340, a first hardware component 122a and communication terminal 315, a second hardware component 122b and communication terminal 325, and an nth hardware component 122n and communication terminal 335. The computing system 120 in FIG. 3 may include additional or fewer elements. Additionally, the elements depicted in FIG. 3 may have functionality different than what is described herein, or the functionality of one element may be attributable to a different element. Moreover, depending on the configuration, some of the functionality provided by depicted elements may be provided by elements external to the elements depicted in FIG. 3.

The communication terminals 315, 325, 335 may provide hardware interfaces allowing components 122a, 122b, 122n to transmit telemetry data objects to the agent 124 for monitoring and analysis. The communication terminals 315, 325, 335 may include signal-processing circuitry capable of formatting raw sensor or firmware event data into standardized digital packets that conform to the telemetry schema defined by the orchestrator 110. The communication terminals 315, 325, 335 may operate through wired physical interfaces such as Ethernet, serial bus, or PCIe lanes, or through wireless transceivers employing standardized protocols such as WI-FI or BLUETOOTH depending on system architecture.

The communication terminals 315, 325, 335 may encapsulate operational status parameters (such as temperature, error counts, read/write statistics, or power consumption) into data objects tagged with component identifiers and timestamps. Each communication terminal 315, 325, 335 may also implement low-level buffering and checksum logic to provide data integrity during transmission to the agent 124, reducing signal loss within high-volume telemetry streams.

The agent 124 may poll these communication terminals 315, 325, 335 periodically or asynchronously, depending on configured telemetry push/pull modes, to capture the latest state information for diagnostic processing.

In some aspects, the communication terminals 315, 325, 335 may be implemented in multiple structural and functional variations to suit differing system architectures and reliability requirements. The communication terminals 315, 325, 335 may operate as a distributed set of I/O endpoints within a cluster of machines, allowing parallel data aggregation and synchronization through message-queue protocols such as MQTT or AMQP. By continuously furnishing verified telemetry data to the agent 124, the communication terminals 315, 325, 335 enables near-real-time visibility into hardware performance necessary for predictive health analysis within the computing environment.

### EXAMPLE DATA FLOW

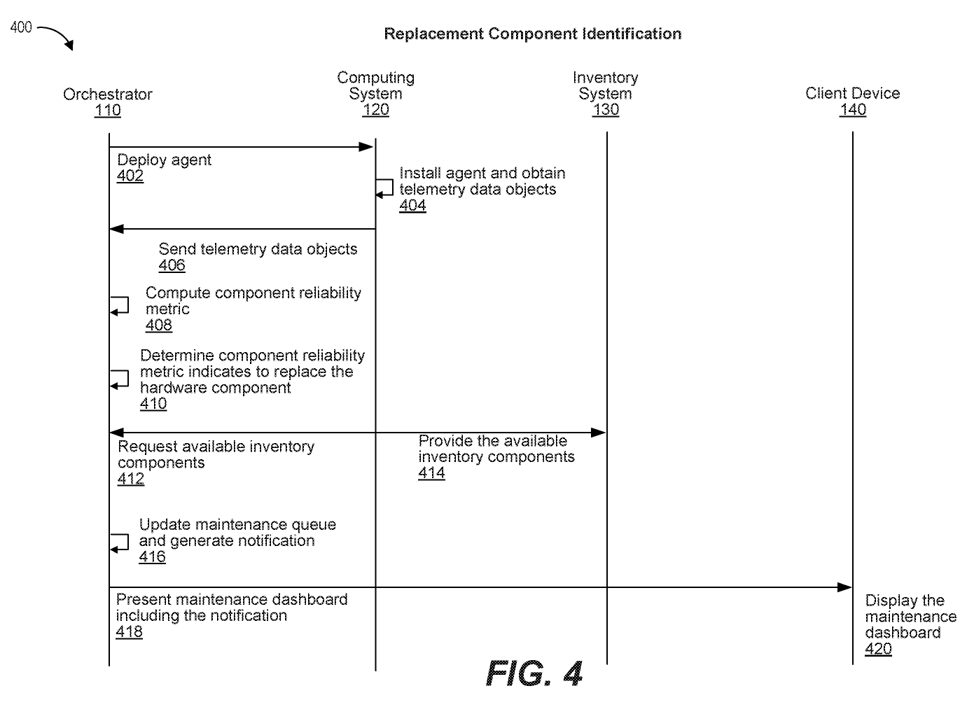

FIG. 4 is an interaction diagram for replacement component identification within a distributed maintenance management workflow, according to an example aspect. The workflow 400 illustrates interactions between an orchestrator 110, a computing system 120, an inventory system 130, and a client device 140. In various configurations, the illustrated workflow 400 may include additional interactions, and the interactions may occur in a different order. Moreover, one or more of the interactions in the workflow 400, or the workflow 400 itself, may be repeated.

At 402, in one aspect, the orchestrator 110 includes deploys (e.g., transmits and installs) an agent 124 onto the computing system 120. The agent engine 210 may assemble deployment packages containing binaries, configuration scripts, and authentication credentials (root or administrative keys) specific to the target OS. During initialization, the orchestrator 110 establishes a secure communication channel (such as an HTTPS or TLS handshake) to transmit the packages.

At 404, the computing system 120 installs the agent 124 and obtains telemetry data objects. The orchestrator 110 may further verify installation success through receipt of a completion acknowledgment message, stored within a deployment log for audit tracking.

The agent engine 210 may optionally include adaptive deployment modes such as push, pull, or pre‑installation deployment. In a push mode, the orchestrator 110 actively connects via a secure protocol and uploads the agent binary; in a pull mode, the computing system 120 retrieves the package from a specified URL. The support for containerized installations (for example, KUBERNETES or DOCKER images) enables scaling across thousands of host devices. Each deployment instance may generate a unique registration token to validate telemetry submissions and allow version consistency of the agent across a heterogeneous infrastructure

In one aspect, the computing system 120 executes the deployed agent 124 as a background process (such as a daemon) that obtains telemetry data objects from hardware components 122 located in the physical chassis of the computing system 120. The agent 124 queries firmware-level interfaces, registers, and OS resources to capture metrics such as temperature, voltage, throughput, error‑counter readings, and serial identifiers. These readings are normalized into structured telemetry objects (such as, JSON or XML format) and are timestamped using synchronized clocks.

At 406, the computing system 120 may send the telemetry data objects to the orchestrator 110 for processing. The orchestrator 110 parses and cleans the received data to remove invalid strings or missing identifiers.

At 408, the orchestrator 110 computes a component reliability metric that quantitatively represents the dependability of each monitored hardware unit. The metric may include an AFR, MTBF or availability metrics which the orchestrator may calculate by comparing current telemetry characteristics against historical records stored within a data store 250. The availability metric may include total system/BIOS/OS/kernel count, total deployment time (days), total available time (days) and availability percentage. The availability metric may correspond to a percentage of time the hardware component 122, computing system 120, or other component operates (for example, time duration without failure). For example, a server may have a 97% uptime availability which includes the components and software installed. The availability metric may be associated with the vendor name, model, BIOS, OS and kernel versions and any combination of those items. By applying heuristic and diff‑analysis algorithms, the orchestrator 110 detects deviations in component health with slot‑level granularity.

At 410, the orchestrator 110 determines component reliability metric indicated to replace the hardware component 122. For example, the orchestrator 110 evaluates normalized telemetry data and performance trends over time, referencing failure rulesets (for example, SMART codes or manufacturer‑defined thresholds) to confirm that degradation has exceeded acceptable limits. In response to confirming a replacement condition, the orchestrator 110 constructs a structured replacement‑component query containing vendor, model, serial number, firmware version, slot identification, and required compatibility parameters.

At 412, the orchestrator 110 requests available inventory components for replacing the hardware component 122. The orchestrator 110 may send a query to the inventory system 130, for example, via an application programming interface 255. The inventory system 130 may perform a database search for components that match electrical, mechanical, and firmware compatibility criteria. The inventory system 130 may reference facility‑specific inventory metadata, including rack number, bin identifiers, and quantity on hand

At 414, the inventory system 130 provides the available spare inventory components. The inventory system 130 may provide the available spare inventory components as one or more candidate replacement components with location descriptors via a secure response object to the orchestrator 110. These results are stored within the predictive maintenance data structure for subsequent maintenance scheduling.

At 416, in one aspect, the orchestrator 110 updates a maintenance queue 245 and generates a notification identifying the matched replacement component and associated scheduling information. The maintenance queue functions as a workflow controller that orders maintenance actions according to severity and resource availability.

At 418, the orchestrator 110 presents a maintenance dashboard including the notification. For example, the orchestrator 110 renders a web‑based maintenance dashboard containing lists of affected systems, reliability scores, and replacement logistics. The dashboard may display slot‑level mapping (for example, “DIMM A2,” “PCI slot 3”) together with compatible part identifiers and inventory location tags.

The dashboard presentation pipeline may utilize secure WebSocket or REST‑based data exchange to refresh interface elements in real‑time. Diagnostic tiles and plots corresponding to each monitored component are automatically generated based on telemetry inputs and predictive‑failure conditions detected by the orchestrator 110.

At 420, the client device 140 displays the maintenance dashboard. In one aspect, the client device 140 includes a graphical interface coupled to a backend data API that receives dashboard content from the orchestrator 110. The interface may be a web browser or a dedicated application 142. The client device 140 renders the dashboard, displaying the notification generated at 414 and providing actionable fields for maintenance review or scheduling acknowledgment. Display modules may implement dynamic sorting by data center, rack location, or failure severity, and employ secured channels to transmit responses back to the orchestrator 110 confirming maintenance actions.

### EXAMPLE FLOWCHART

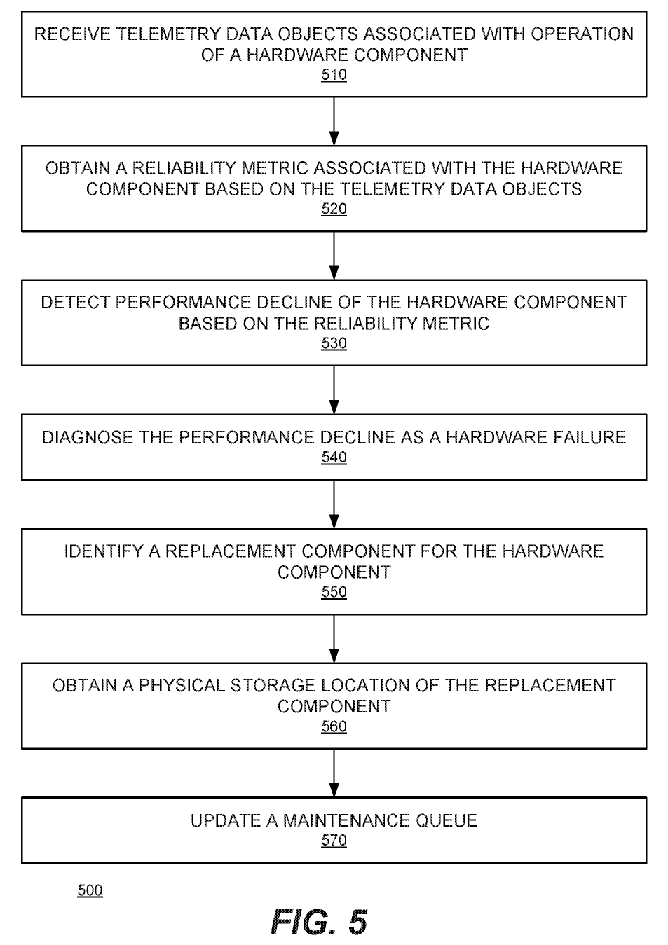

FIG. 5 is a flowchart depicting an example process 500 for replacement component identification, in accordance with some aspects. The process may be performed by the orchestrator 110 and any component illustrated in FIG. 2. The process 500 may be embodied as a software algorithm that may be stored as computer instructions that are executable by one or more processors. The instructions, when executed by the processors, cause the processors to perform various steps in the process 500. In various examples, the process may include additional, fewer, different steps, or in a different order. While various steps in process 500 may be discussed with the use of orchestrator 110, each step may be performed by a different computing device.

The orchestrator 110 may receive 510 telemetry data objects associated with operation of a hardware component 122. In some cases, the orchestrator 110 may deploy an agent 124 to capture telemetry data objects. The telemetry data objects may be machine-readable telemetry packets suitable for backend processing. The telemetry data may include granular diagnostic attributes from the hardware component 122, such as chassis position, temperature readings, throughput values, error-code registers, and firmware version identifiers.

In some examples, the orchestrator 110 may receive the telemetry data according to defined temporal and event-driven conditions. For example, the agent engine 210 may initialize a scheduler for telemetry data collection at predetermined intervals, ensuring consistent telemetry data coverage across operational cycles for continuous performance tracking. The agent 124 may identify event hooks (such as device insertion or removal, firmware upgrade notifications, temperature excursions, or error log generation) to initiate asynchronous telemetry data captures. In response to such an event, the agent 124 executes a diagnostic routine. The diagnostic routine may include polling relevant registers and counters to gather snapshot data describing a state transition of the affected hardware component 122.

The orchestrator 110 may combine both periodic and event-triggered telemetry data objects. The orchestrator 110 may merge the telemetry data objects into a unified diagnostic dataset. The orchestrator 110 may store the telemetry data objects locally (for example, in the data store 250).

In some examples, the agent engine 210 selects the agent 124 to deploy on the computing system 120 according to OS parameters associated with the computing system 120. For example, during initial configuration of the agent 124, the agent engine 210 queries the computing system 120 to determine OS characteristics. For example, the characteristics may include distribution type, kernel version, and available system libraries. The agent engine 210 may provision an agent package compatible with these parameters. For LINUX-based systems, the agent 124 may be deployed as executable shell or PYTHON scripts capable of interfacing with procfs or sysfs directories to extract component-level telemetry data. For WINDOWS systems, the agent 124 may use compiled binaries accessing WMI or WinAPI interfaces to gather corresponding data. In virtualized or hypervisor environments such as VMWARE, the agent 124 operates through host-level APIs to obtain virtual hardware statistics without interfering with active workloads. Each agent variant includes a common communication protocol and serialization format, for example JSON transmitted via HTTPS, enabling interoperability with a centralized orchestrator 110 regardless of OS-specific implementation differences. By tailoring the agent architecture to the OS parameters of the computing system, the diagnostic process achieves reliable data acquisition and efficient resource utilization, ensuring that cross-platform components within a heterogeneous infrastructure can be uniformly monitored and managed.

In some examples, each telemetry data object includes the chassis position of the hardware component 122 within the computing system 120. The chassis information identifies the physical positional index of the component 122, for example, by obtaining firmware tables and motherboard configuration descriptors to determine slot mapping (such as “DIMM A2” or “PCI slot 3”) in accordance with the vendor’s labeling scheme. The orchestrator 110 correlates hardware performance with the chassis position to generate a structured record to associate each measurement with a specific physical location inside the chassis. This coupling of health readings and positional data enables precise localization of the monitored hardware component 122 during diagnostics and underpins accurate root cause identification and component replacement workflows for the computing system 120.

In some examples, the orchestrator 110 may timestamp each received telemetry data object , for example, using a synchronized system clock derived from a network time protocol (NTP) source, ensuring temporal alignment across telemetry data objects for subsequent correlation operations. By maintaining ongoing data acquisition processes, the orchestrator 110 provides continuous visibility of component behavior and context aware understanding of operating conditions within heterogeneous infrastructure environments.

In some examples, the orchestrator 110 generates a timestamped health and change history for the hardware component 122 to represent operational progression over time. In response to receiving current telemetry data objects, the orchestrator 110 compares the current telemetry data objects against previously persisted telemetry data objects to identify variations.

In some cases, in response to the orchestrator 110 detecting a change, the orchestrator 110 generates a new record object containing attributes associated with the change. For example, the attributes may identify a type, affected component identifier, event timestamp, and/or the like. The orchestrator 110 may store the object in a relational or time-series database. Each entry may link bi-directionally to prior entries, forming a persistent audit chain that yields a complete life-cycle view of hardware and software modifications associated with the hardware component 122. The timestamped continuity of these health records allows verifiable traceability of configuration dynamics, enabling accurate reconstruction of system state at any prior time instance.

In some aspects, the orchestrator 110 obtains 520 a reliability metric associated with the hardware component 122 based on the telemetry data objects. The reliability metric may be a data-driven indicator that measures the dependability and performance stability of hardware components 122 (and/or a computing system 120), for example, across a fleet.

In some examples, the reliability metric includes an annual failure rate (AFR). The AFR may be a percentage of components failing in a rolling 12-month period (or another time frame). The orchestrator 110 may analyze timestamped telemetry data objects to determine a number of failure occurrences within a defined time interval relative to a failure standard (for example, the failure standard may be with respect to failures for a total population of active components). The orchestrator 110 may parse the telemetry data objects to exclude transient errors and classify hard versus predictive failures so that confirmed degradation events are included in the AFR calculation. The orchestrator 110 may normalize the failure count over a target time period (such as one-year period), dividing by the total number of components deployed (for example, in the computing system 120 and/or across the fleet) to produce a percentage value representing expected annual failure probability. The orchestrator 110 may store the resulting AFR metric in the data store 250 and update dynamically whenever additional telemetry data objects are received. By computing the AFR in this manner, the orchestrator 110 enables autonomous health forecasting and data-driven maintenance planning for hardware components.

In some examples, the reliability metric includes a mean time between failure (MTBF). The MTBF may be a total aggregated runtime of the hardware component 122 divided by a number of failures. The orchestrator 110 obtains the MTBF metric associated with the hardware component 122 by evaluating operational uptime durations encoded in telemetry data objects. The orchestrator 110 may aggregate continuous operational time between the start and end of each failure event for the hardware component 122 and compute the average elapsed time separating consecutive confirmed failures. To perform this operation, the orchestrator 110 may query the data store 250, which maintains historical usage intervals collected from firmware counters, performance monitors, or environmental sensors. The MTBF calculation may include preprocessing steps to synchronize timestamps across the telemetry data objects and to filter non-hardware-related anomalies that could distort reliability results. The orchestrator 110 may express the calculated MTBF in hours or cycles and associate the MTBF with component identifiers, firmware versions, and deployment conditions to enable comparison across hardware components. This value may be periodically re-evaluated as new operational data becomes available, providing real-time reliability insight to guide preventative maintenance scheduling and procurement optimization. The MTBF metric thus serves as a temporal measure that the orchestrator 110 uses to quantify the dependability and expected service life of the hardware component 122.

In some examples, the reliability metric may include an availability metric. The availability metric may include total system/BIOS/OS/kernel count, total deployment time (days), total available time (days) and availability percentage. The availability metric may correspond to a percentage of time the hardware component 122, computing system 120, or other component operates (for example, time duration without failure). For example, a server may have a 97% uptime availability which includes the components and software installed. The availability metric may be associated with the vendor name, model, BIOS, OS and kernel versions and any combination of those items.

In some examples, the reliability metric may identify failure trends by firmware, BIOS, kernel, or OS installed on the hardware component 122. The orchestrator 110 may correlate telemetry data objects containing version metadata with recorded failure instances to generate comparative reliability profiles per software release. To achieve this, the orchestrator 110 may classify the hardware components 122 by version identifiers and compute separate AFR, MTBF, availability metrics, and/or the like for each group, thereby measuring how changes in low-level code impact device stability. The orchestrator 110 may detect statistically significant deviations indicating a particular firmware version produces elevated fault rates. By evaluating reliability trends in this manner, the orchestrator 110 enhances the computing environment’s overall resilience and allows version management decisions that are based on empirical reliability data.

In some examples, the orchestrator 110 detects 530 a performance decline of the hardware component 122. For example, the orchestrator 110 may detect the performance decline based on the reliability metric, the telemetry data objects, and/or the like. In some examples, the orchestrator 110 may detect changes across the telemetry data objects, which may correlate the performance decline events with underlying component-level modifications. The orchestrator 110 may compare timestamps associated with the changes with preceding configuration changes to identify potential causal factors. For example, the causal factors may be firmware update, a newly installed device driver, a thermal throttling event, and/or the like. The orchestrator 110 may further compute confidence scores representing a likelihood that a given event contributed to the observed decline using weighted relational models (for example, the confidence score may be based on temporal relationship, such as an event occurring closer in time increases the confidence score). By systematically linking performance deviations to precise modification timestamps, the orchestrator 110 enables component-level performance degradation determination.

In some examples, the orchestrator 110 may perform trend analysis to evaluate telemetry data objects. The orchestrator 110 may collect the telemetry data objects, which may include error counters such as drive read/write retries, memory ECC correction events, cache integrity checks, BIOS anomalies, and kernel panic traces. The orchestrator 110 may pre-process the metrics through time-series aggregation and rolling average windows to identify gradual performance deterioration or anomaly deviation patterns relative to baseline operation profiles. By continuously comparing the observed data trends to known performance thresholds and historical outcomes, the system accurately isolates emerging indicators of component instability, providing a reliable predictive foundation for subsequent failure identification and remediation workflows.

In some examples, the orchestrator 110 applies component-specific heuristics and static rules that encapsulate known failure behaviors derived from historical component performance data. The data store 250 may store the historical component performance data containing failure signature definitions describing contextual relationships between telemetry data objects and potential component faults (such as mapping a specific sequence of disk write retries and access latency oscillations to a likely mechanical head deterioration). The rule sets may be implemented as “if-then” condition triggers executed by the orchestrator 110, which evaluates incoming telemetry data objects for statistical conformity to threshold conditions defined within the heuristic rules. In response to identification of a qualifying pattern, the orchestrator 110 flags the hardware component 122 as an at-risk element and assigns a predicted failure window, for example, a 28-day period preceding probable read/write malfunction based on model-specific attributes. The use of component-specific heuristics allows the orchestrator 110 to apply deterministic reasoning immediately upon deployment, establishing a baseline predictive capability that integrates seamlessly with broader diagnostic and remediation subsystems.

In some examples, the orchestrator 110 correlates telemetry data object patterns with verified failure outcomes over time by using a machine learning algorithm. The orchestrator 110 consumes anonymized operational logs, event histories, and repair records captured by the agent network and aggregates into feature vectors representing failure precursors under multiple operating conditions. In some cases, supervised and semi-supervised training pipelines may cause recalibration of existing heuristic weights, identifying new predictive variables that may precede aggregated fault incidents. The trained machine learning models may periodically deploy back to the predictive diagnostic pipeline through model update services, where the models operate autonomously to detect subtle multivariate symptoms not expressible by static rule sets. This adaptive refinement process transforms the system’s predictive mechanism into a self-improving failure detection engine that reduces false positives while expanding detection coverage across hardware and software domains.

The component performance system 220 may compute differential values between the telemetry data objects to quantify any degradation relative to historical baselines or manufacturer-defined thresholds. In response to the sequential analysis indicating a negative deviation trend exceeding a configured tolerance window, the component performance system 220 flags the hardware component 122 as exhibiting a performance decline and outputs a diagnostic indicator. In this way, the performance comparison operation enables the orchestrator 110 to continuously detect and characterize early signs of degradation in hardware components 122 before failure events occur.

In some examples, the component performance system 220 performs a diff analysis on the telemetry data objects to detect performance decline by programmatically comparing string and numerical elements representing hardware performance information. The diff analysis process begins by parsing each telemetry object into ordered key-value pairs, where each key corresponds to a monitored parameter field such as “component_temperature,” “I/O_throughput,” or “SMART_error_code,” and each value represents the latest reported measurement. The component performance system 220 performs field-by-field comparison between the current and prior telemetry objects for the same hardware identifier, computing string or character-level differences for symbolic fields and numerical deltas for quantitative values. The component performance system 220 records change vectors that quantify the degree, direction, and rate of variation, storing these vectors in a transient analysis table within the data store 250 for aggregation over successive cycles. When cumulative diff results reveal consistent performance regression (such as steadily increasing response latency or error-rate string alterations beyond specified thresholds) the component performance system 220 classifies the condition as an impending decline and propagates the result to components of the orchestrator 110 (for example, to the inventory management system 235, ticketing system 240, and/or the like). Through this structured diff comparison of telemetry string elements, the orchestrator 110 provides a deterministic mechanism for discovering subtle deviations in component behavior, efficiently supporting predictive maintenance workflows within the computing system 120.

In some examples, the orchestrator 110 enables historical comparison across multiple computing systems to determine recurring or systemic issues over time. The orchestrator 110 may generate fleet-wide datasets indexed by component type (and/or firmware, software versions), allowing comparative analysis between systems operating under similar conditions. Through statistical aggregation procedures, such as failure-rate computation and trend line fitting, the orchestrator 110 identifies correlated degradation patterns indicative of non-random or version-specific performance anomalies. In response to patterns exceeding predefined thresholds, automated alert routines may initiate preventative maintenance workflows or procurement recommendations to replace unreliable component models. This cross-system historical analysis transforms localized health data into predictive operational intelligence, reinforcing overall infrastructure reliability and lifecycle optimization.

In some examples, the orchestrator 110 diagnoses 540 the performance decline as a hardware failure. In some examples, the orchestrator 110 may diagnose the performance decline as a hardware failure according to comparison with domain-specific failure rules. The orchestrator 110 obtains real-time telemetry data objects and provides the telemetry data objects through if-then heuristic rules. The rules represent known degradation symptoms, such as sustained error accumulation or recurrent power-state anomalies. The orchestrator 110 may dynamically weigh the rules according to contextual indicators (such as firmware version, machine age, or environmental temperature) so that diagnostic conclusions reflect hardware-specific probability models rather than generalized assumptions. By executing heuristic processes in this fashion, the orchestrator 110 produces rapid, data-driven determinations of whether a performance decline results from impending or present hardware failure, ensuring efficient fault isolation across large infrastructure fleets.

In some examples, the orchestrator 110 may diagnose the performance decline as a hardware failure by measuring current telemetry of the hardware component 122 against predefined threshold reliability metrics. The orchestrator 110 may retrieve baseline metrics for AFR, MTBF, availability metrics, and/or the like that define permissible operational ranges. The orchestrator 110 compares the reliability metric to the thresholds. In response to the reliability metric exceeds the reliability threshold, the orchestrator 110 classifies the performance decline as hardware degradation and triggers prescriptive repair workflows. For example, the orchestrator 110 may identify AFR of the hardware component 122 as 18% (and in some cases AFR according to spec is 1%). The orchestrator 110 may generate a hardware failure indicator (such as a communication packet payload element updated to reflect the hardware failure indicator). By measuring the telemetry state against calibrated failure thresholds, the orchestrator 110 enables precise identification of hardware faults, thereby reinforcing infrastructure command and control and maintaining reliable application performance.

In some examples, the orchestrator 110 identifies 550 a replacement component for the hardware component 122. For example, the orchestrator 110 may query an inventory system 130 to locate a compatible replacement component after identifying a performance decline in the hardware component 122. The inventory management system 235 transmits a structured query from metadata of the degraded component, such as vendor, model, serial number, firmware revision, and slot identification. The inventory management system 235 may communicate with the inventory system 130 through a secure API (such as the application programming interface 255) or database interface to the inventory system 130.

In response to receiving the query, the inventory system 130 parses the request parameters and executes a search across indexed configuration records that describe managed components and spare assets within the computing infrastructure. The inventory system 130 compares the request parameters against stored component attributes, including compatibility rules and current deployment statuses, to identify a replacement part. The replacement part may match electrical, mechanical, and firmware requirements of the hardware component 122. For example, the replacement component may exactly match a string associated with the hardware component 122 (such as vendor make and model). In some cases, the orchestrator 110 references a lookup table, including predetermined mappings between the hardware component 122 and the replacement component.

In some examples, the inventory system 130 maintains location-aware metadata describing the physical storage position of each replacement component within a facility to enable accurate maintenance scheduling. For example, the location-aware metadata organizes component records by hierarchical location descriptors (such as data center identifier, rack number, chassis slot, and bin code to locate the replacement part) associated with each available spare part. The inventory system 130 provides the logical record describing the part and/or the location-aware metadata to the orchestrator 110.

In some examples, the orchestrator 110 obtains 560 the physical storage location of the replacement component. For example, the orchestrator may receive the location-aware metadata from the inventory system 130 to identify the physical storage location.

In some examples, the orchestrator 110 updates 570 a maintenance queue 245. In some cases, the component performance system 220 may send telemetry data objects including component reliability scores, failure predictions, location-aware metadata, and/or the like to the ticketing system 240. The ticketing system 240 may send a predictive maintenance ticket to a maintenance dashboard layer via an internal API.

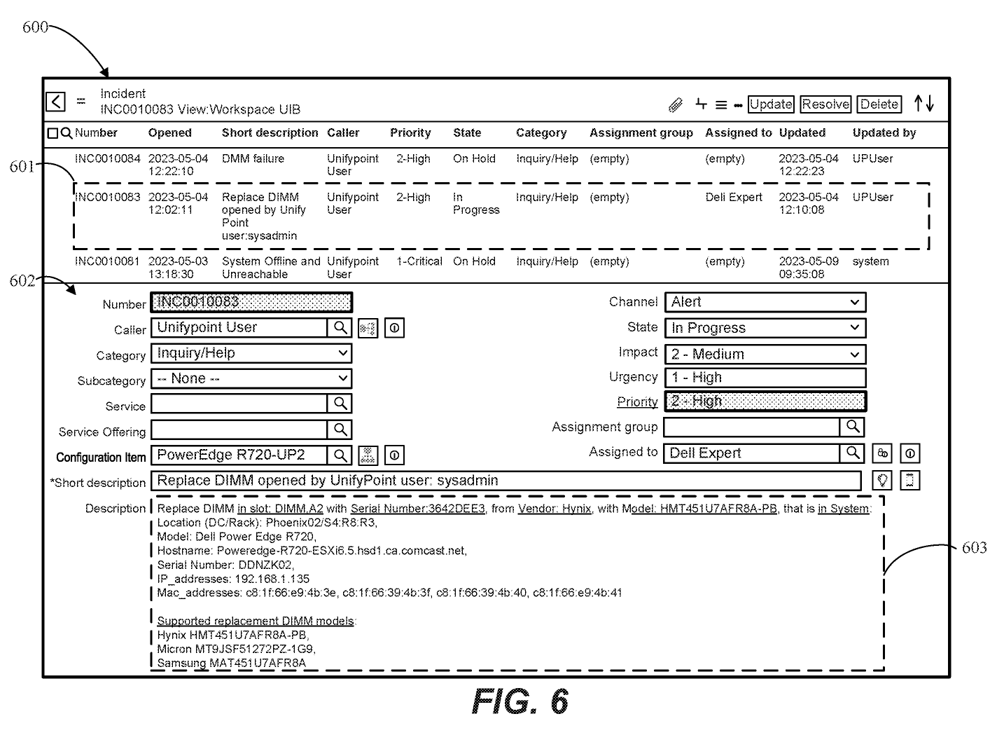

The dashboard receives the predictive maintenance ticket and parses the ticket into structured graphical elements (such as tables and charts as illustrated in FIG. 6). The dashboard refreshes the render state to reflect the latest predictive maintenance outcomes. The dashboard provides real-time predictive insight into component health status and maintenance forecasts for the entire computing infrastructure. In some examples, the maintenance dashboard operates as an interactive visualization interface that indicates the diagnostic status of components within the information technology infrastructure.

In some examples, the maintenance dashboard updates its interface to include detailed positional and inventory metadata related to hardware components and their designated replacements. The orchestrator 110 aggregates the chassis data (such as vendor silkscreen identifiers indicating chassis positions like “DIMM A2” or “PCI 3”) alongside replacement component records retrieved from the configuration management and inventory databases. By incorporating chassis mapping and physical storage location details into the maintenance dashboard’s update cycle, the system provides a comprehensive end-to-end view of component diagnostics, replacement readiness, and physical asset traceability within the computing infrastructure.

### EXAMPLE INTERFACE

FIG. 6 illustrates an example maintenance dashboard generated and presented by the orchestrator 110. In one aspect, interface 600 represents a computer-implemented incident management interface executed by the orchestrator 110. The orchestrator 110 may render the interface 600 through a web-based client connected via encrypted HTTPS protocols to the backend database. The interface 600 may include a graphical user interface layer coupled to program logic that receives the telemetry data objects generated by the agent 124 installed on the computing system 120.

The interface 600 displays structured incident information including a record number, creation timestamp, description, caller identity, priority level, and assigned remediation personnel. Each record may be stored as an object that includes relational data fields linking to configuration items, machine identity data, and prescriptive repair instructions. The display layer periodically synchronizes with the underlying ticket database such that updates to incident state (“In Progress,” “On Hold,” “Closed”) propagate automatically according to validation signals received from machines after repair verification.

In some examples, a maintenance queue element 601 may be associated with an active incident record (“INC0010083”). A dashboard element 602 may include further details associated with the maintenance queue element 601. For example, the dashboard element 602 may include an instruction field 603. The instruction field 603 stores detailed corrective action information produced by the predictive maintenance engine. The instruction field 603 includes text data specifying the slot location of the faulty component (for example, “DIMM_A2”), the serial number, vendor, model number, and machine identifiers including data center, rack address, hostname, and network addresses. The instruction field 603 may include a list of compatible replacement parts determined by querying a local or cloud-hosted inventory database. Each supported model entry may be cross-referenced against system validation rules stored by the backend software such that the resulting recommendation complies with vendor specifications and firmware compatibility.

### EXAMPLE DATA FLOW

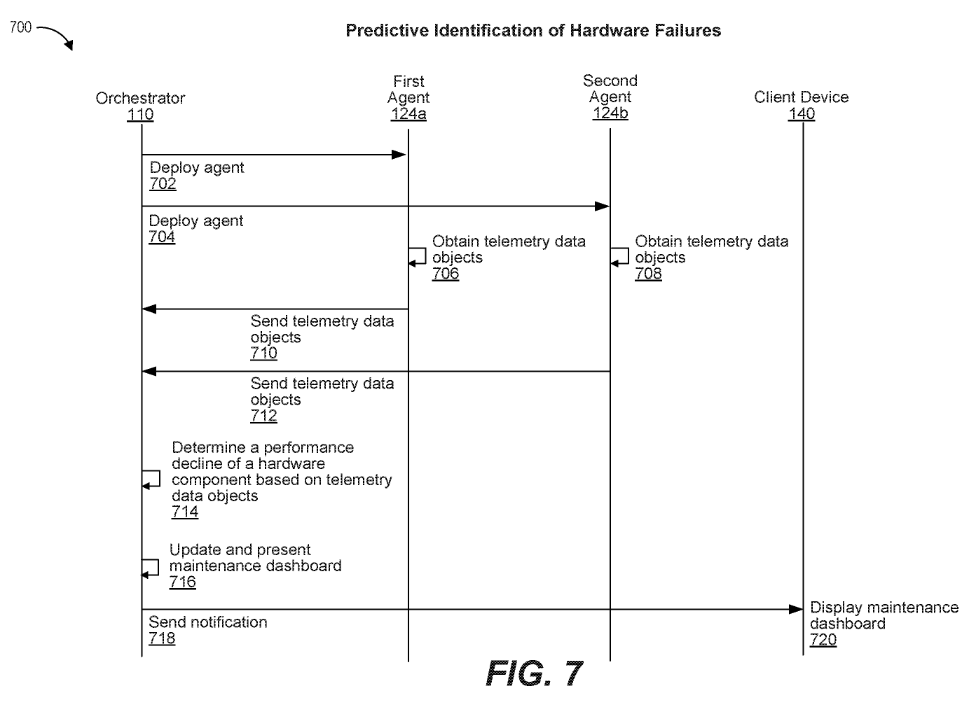

FIG. 7 is an interaction diagram for predictive identification of hardware failure within a distributed maintenance management workflow, according to an example aspect. The workflow 700 illustrates interactions between an orchestrator 110, a first agent 124a, a second agent 124b, and a client device 140. In various configurations, the illustrated workflow 700 may include additional interactions, and the interactions may occur in a different order. Moreover, one or more of the interactions in the workflow 700, or the workflow 700 itself, may be repeated.

At 702, in one aspect, the orchestrator 110 deploys a first agent 124a (such as agent 124) onto a computing system 120 for predictive identification of hardware failures. The agent engine 210 assembles deployment packages containing binaries, configuration scripts, and authentication credentials (for example, root or administrative keys) specific to the OS of the computing environment. In response, the targeted computing system executes the installation routine, which registers the agent 124 with a backend telemetry collection service of the orchestrator 110 and configures persistent execution at system startup. The orchestrator 110 may verify completion through an installation acknowledgment message or registration token persisted in a deployment log for audit tracking.

The agent engine 210 may optionally include adaptive deployment mechanisms such as push, pull, or pre-installation modes. In a push mode, the orchestrator 110 initiates and uploads the agent binary directly into the computing system; in a pull mode, the computing system retrieves an installation package, for example, from a configuration-defined URL or cloud repository; in pre-installation, the computing system inherits the agent from the network image used to deploy it and executes the agent upon boot. Each newly deployed agent generates a unique registration identifier used to authenticate subsequent telemetry transmissions and synchronize version control within the orchestrator network.

At 704, the orchestrator 110 deploys a second agent 124b (such as agent 124)onto a different computing system 120 for predictive identification of hardware failures. The orchestrator 110 performs the same (or similar) actions as in step 702.

At 706, the first agent 124a obtains telemetry data objects. The data-capture operations may include aggregating telemetry data objects containing environmental and performance metrics. In one aspect, the first agent 124a executes as a resident background process (such as a daemon) to gather and buffer telemetry data objects. For example, the first agent 124a queries local firmware interfaces, sensor registers, and device drivers associated with the hardware component to collect metrics such as operating temperature, voltage, data throughput, error-counter readings, power state, and serial identifiers. The packets may include chassis position information (such as slot-level identifiers), vendor and model information, and performance attributes (for example, I/O latency, SMART error counts, or power-on hours).

At 708, the second agent 124b obtains telemetry data objects. The second agent 124b performs the same (or similar) actions as in step 706.

At 710, the first agent 124a sends the telemetry data objects to the orchestrator 110. In some cases, the agent 124 normalizes the collected readings into structured packets (for example, encoded in JSON or XML format) and applies timestamps generated from network-synchronized clocks (for example, NTP-based) to maintain temporal accuracy. To reduce bandwidth, the agent 124 may employ delta compression or diff-reporting to transmit only the parameter variations relative to the previous reporting interval. In response to completion, telemetry data objects are serialized and dispatched to the orchestrator 110. The orchestrator 110 correlates inputs from both 122a and 122b to build comparative performance baselines across components.

At 712, the second agent 124b sends the telemetry data objects. The second agent 124b performs the same (or similar) actions as in step 710.

At 714, in one aspect, the orchestrator110 determines a performance decline of a hardware component based on the telemetry data objects. The orchestrator 110 analyzes incoming telemetry data to determine a performance decline within one or more hardware components. The component performance system 220 computes reliability metrics such as AFR, MTBF, availability metrics, and/or the like by comparing time-stamped telemetry packets against historical baselines. A diff analysis and/or trend-detection algorithm may quantify deviations in throughput, latency, and temperature. When the deviations exceed predefined tolerance thresholds, the orchestrator 110 flags the corresponding hardware component as performance-degraded and stores diagnostic markers in data store 250 for correlation with predictive failure models.

At 716, the orchestrator 110 updates and presents a maintenance dashboard reflecting current component reliability assessments. The dashboard interface aggregates data, for example, from the maintenance queue 245 and telemetry system 215, rendering graphical tiles and charts that display component identifiers, health states, and predicted failure intervals.

At 718, the orchestrator 110 sends a notification to the client device 140. The notification indicating one of the hardware components is exhibiting a forecasted failure condition. The presentation layer may utilize REST-based or WebSocket-based protocols to enable real-time updates. A user accessing the dashboard through a client session on the orchestrator 110 can review deterioration trends and queued replacement advisories.

At 720, the client device 140 displays the maintenance dashboard. In some cases, the notification from the orchestrator 110 indicates that the hardware component exhibits the forecasted failure condition. In response to receipt, the client device 140 renders an alert interface and synchronizes with backend systems for confirmation of maintenance scheduling. This secure notification exchange allows immediate awareness of predictive maintenance conditions by authorized operators.

In one aspect, the client device 140 displays the maintenance dashboard updated by the orchestrator 110, enabling visualization of active alerts and predictive failure forecasts. Through a graphical user interface, a user may view entries representing each monitored component along with slot location, vendor details, reliability metrics, and inventory-linked replacement options. The interface enables acknowledgment or escalation commands that post responses back to the orchestrator 110 via secure API calls, thereby closing the interaction loop within the predictive maintenance workflow.

### EXAMPLE FLOWCHART

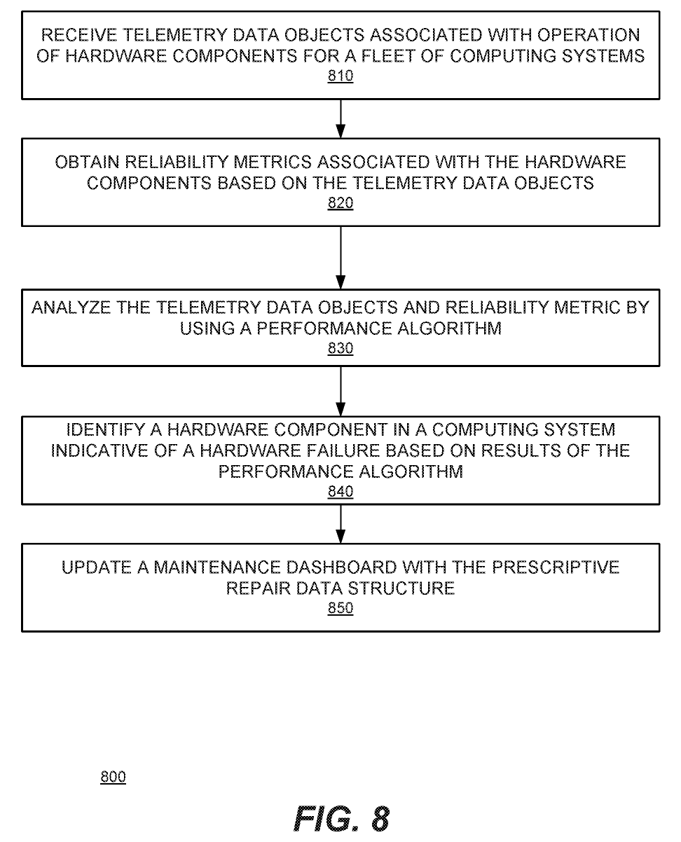

FIG. 8 is a flowchart depicting an example process 800 for predictive identification of hardware failures, in accordance with some aspects. The process may be performed by the orchestrator 110 and any component illustrated in FIG. 2. The process 800 may be embodied as a software algorithm that may be stored as computer instructions that are executable by one or more processors. The instructions, when executed by the processors, cause the processors to perform various steps in the process 800. In various examples, the process may include additional, fewer, different steps, or in a different order. While various steps in process 800 may be discussed with the use of orchestrator 110, each step may be performed by a different computing device.

The orchestrator 110 may receive 810 telemetry data objects associated with operation of hardware components 122. In some cases, the orchestrator 110 may deploy an agent 124 to capture telemetry data objects. The telemetry data objects may be machine-readable telemetry packets suitable for backend processing. The telemetry data may include granular diagnostic attributes from the hardware component 122, such as chassis positions, temperature readings, throughput values, error-code registers, and firmware version identifiers.

In some examples, the orchestrator 110 may receive the telemetry data according to defined temporal and event-driven conditions. For example, the agent engine 210 may initialize a scheduler for telemetry data collection at predetermined intervals, ensuring consistent telemetry data coverage across operational cycles for continuous performance tracking. The agent 124 may identify event hooks (such as device insertion or removal, firmware upgrade notifications, temperature excursions, or error log generation, among others) to initiate asynchronous telemetry data captures. In response to such an event, the agent 124 executes a diagnostic routine. The diagnostic routine may include polling relevant registers and counters to gather snapshot data describing a state transition of the affected hardware component 122.

The orchestrator 110 may combine both periodic and event-triggered telemetry data objects. The orchestrator 110 may merge the telemetry data objects into a unified diagnostic dataset. The orchestrator 110 may store the telemetry data objects locally (for example, in the data store 250).

In some examples, the agent engine 210 selects the agent 124 to deploy on the computing system 120 according to OS parameters associated with the computing system 120. For example, during initial configuration of the agent 124, the agent engine 210 queries the computing system 120 to determine OS characteristics. For example, the characteristics may include distribution type, kernel version, build, and available system libraries. The agent engine 210 may provision an agent package compatible with these parameters. For LINUX-based systems, the agent 124 may be deployed as executable shell or PYTHON scripts capable of interfacing with procfs or sysfs directories to extract component-level telemetry data. For WINDOWS systems, the agent 124 may use compiled binaries accessing WMI or WinAPI interfaces to gather corresponding data. In virtualized or hypervisor environments such as VMWARE, the agent 124 operates through host-level APIs to obtain virtual hardware statistics without interfering with active workloads. Each agent variant includes a common communication protocol and serialization format, for example JSON transmitted via HTTPS, enabling interoperability with a centralized orchestrator 110 regardless of OS-specific implementation differences. By tailoring the agent architecture to the OS parameters of the computing system, the diagnostic process achieves reliable data acquisition and efficient resource utilization, ensuring that cross-platform components within a heterogeneous infrastructure can be uniformly monitored and managed.

In some examples, each telemetry data object includes the chassis position of the hardware components 122 within the computing system 120. The chassis information identifies the physical positional index of the component 122, for example, by obtaining firmware tables and motherboard configuration descriptors to determine slot mapping (such as “DIMM A2” or “PCI slot 3”) in accordance with the vendor’s labeling scheme. The orchestrator 110 correlates hardware performance with the chassis position to generate a structured record to associate each measurement with a specific physical location inside the chassis. This coupling of health readings and positional data enables precise localization of the monitored hardware components 122 during diagnostics and underpins accurate root-cause identification and component replacement workflows for the computing system 120.

In some examples, the orchestrator 110 may timestamp each received telemetry data object , for example, using a synchronized system clock derived from a network time protocol (NTP) source, ensuring temporal alignment across telemetry data objects for subsequent correlation operations. By maintaining ongoing data acquisition process, the orchestrator 110 provides continuous visibility of component behavior and context-aware understanding of operating conditions within heterogeneous infrastructure environments.

In some examples, the orchestrator 110 generates a timestamped health and change history for the hardware component 122 to represent operational progression over time. In response to receiving current telemetry data objects, the orchestrator 110 compares the current telemetry data objects against previously persisted telemetry data objects to identify variations.

In some cases, in response to the orchestrator 110 detecting a change, the orchestrator 110 generates a new record object containing attributes associated with the change. For example, the attributes may identify a type, affected component identifier, event timestamp, and/or the like. The orchestrator 110 may store the object within a relational or time-series database. Each entry may link bi-directionally to prior entries, forming a persistent audit chain that yields a complete life-cycle view of hardware and software modifications associated with the hardware component 122. The timestamped continuity of these health records allows verifiable traceability of configuration dynamics, enabling accurate reconstruction of system state at any prior time instance.

In some aspects, the orchestrator 110 obtains 820 a reliability metric associated with the hardware component 122 based on the telemetry data objects. The reliability metric may be a data-driven indicator that measures the dependability and performance stability of hardware components 122 (and/or a computing system 120), for example, across a fleet.

In some examples, the reliability metric includes an annual failure rate (AFR). The AFR may be a percentage of components failing in a rolling 12-month period (or another time frame). The orchestrator 110 may analyze time-stamped telemetry data objects to determine a number of failure occurrences within a defined time interval relative to a failure standard (for example, the failure standard may be with respect to failures for a total population of active components). The orchestrator 110 may parse the telemetry data objects to exclude transient errors and classify hard versus predictive failures so that confirmed degradation events are included in the AFR calculation. The orchestrator 110 may normalize the failure count over a target time period (such as one-year period), dividing by the total number of components deployed (for example, in the computing system 120 and/or across the fleet) to produce a percentage value representing expected annual failure probability. The orchestrator 110 may store the resulting AFR metric in the data store 250 and update dynamically whenever additional telemetry data objects are received. By computing the AFR in this manner, the orchestrator 110 enables autonomous health forecasting and data-driven maintenance planning for hardware components.

In some examples, the reliability metric includes a mean time between failure (MTBF). The MTBF may be a total aggregated runtime of the hardware component 122 divided by a number of failures. The orchestrator 110 obtains the MTBF metric associated with the hardware component 122 by evaluating operational uptime durations encoded in telemetry data objects. The orchestrator 110 may aggregate continuous operational time between the start and end of each failure event for the hardware component 122 and compute the average elapsed time separating consecutive confirmed failures. To perform this operation, the orchestrator 110 may query the data store 250, which maintains historical usage intervals collected from firmware counters, performance monitors, or environmental sensors. The MTBF calculation may include preprocessing steps to synchronize timestamps across the telemetry data objects and to filter nonhardware related anomalies that could distort reliability results. The orchestrator 110 may express the calculated MTBF in hours or cycles and associate the MTBF with component identifiers, firmware versions, and deployment conditions to enable comparison across hardware components. This value may be periodically re-evaluated as new operational data becomes available, providing real-time reliability insight to guide preventative maintenance scheduling and procurement optimization. The MTBF metric thus serves as a temporal measure that the orchestrator 110 uses to quantify the dependability and expected service life of the hardware component 122.

In some examples, the reliability metric includes an availability metric. The availability metric may include total system/BIOS/OS/kernel count, total deployment time (days), total available time (days) and availability percentage. The availability metric may correspond to a percentage of time the hardware component 122, computing system 120, or other component operates (for example, time duration without failure). For example, a server may have a 97% uptime availability which includes the components and software installed. The availability metric may be associated with the vendor name, model, BIOS, OS and kernel versions and any combination of those items.

In some examples, the reliability metric may identify failure trends by firmware, BIOS, kernel, or OS installed on the computing system 120. The orchestrator 110 may correlate telemetry data objects containing version metadata with recorded failure instances to generate comparative reliability profiles per software release. To achieve this, the orchestrator 110 may classify the computing system 120 by version identifiers and compute separate AFR, MTBF, availability metrics, and/or the like for each group, thereby measuring how changes in low-level code impact device stability. The orchestrator 110 may detect statistically significant deviations indicating a particular firmware version produces elevated fault rates. By evaluating reliability trends in this manner, the orchestrator 110 enhances the computing environment’s overall resilience and allows version management decisions that are based on empirical reliability data.

The orchestrator 110 analyzes 830 the telemetry data objects by using a performance algorithm. In some examples, the performance algorithm detects error rate trajectories and performance curve patterns, the trajectories and patterns may signal emergent hardware failure trends. The orchestrator 110 may ingest telemetry data objects and the reliability metrics. The performance algorithm may compute rolling averages and time-differentiated slopes of the telemetry data objects and the reliability metrics to model error rate trajectories over operational intervals. The orchestrator 110 applies curve fitting and derivative-based analysis to locate inflection points where the error rate acceleration surpasses a defined threshold relative to historical norms. The component performance algorithm may further corroborate the results by comparing the results to component-specific failure rules (for example, stored in the data store 250) confirm whether the inflection indicates imminent degradation. In response to validating, the orchestrator 110 classifies the pattern as a predictive failure condition for downstream prescriptive remediation. By executing this layered statistical analysis of telemetry behavior, the orchestrator enables early and accurate identification of components exhibiting emergent failure characteristics.

In some examples, the orchestrator 110 analyzes the telemetry data objects by evaluating drive and memory read/write cycle activity against vendor- and firmware-specific endurance limits. The orchestrator 110 may extract metadata from telemetry data objects that indicate cumulative read, write, and erase cycle counts for each monitored storage or memory device. The component performance algorithm compares the values to endurance thresholds defined in the component-specific failure rule set, which incorporates manufacturer specifications and firmware revision data stored within the reliability knowledge repository. The orchestrator 110 calculates the remaining useful life of each device by determining the ratio of current cycle consumption to total rated capacity and applies weighting adjustments reflecting firmware optimizations or wear-leveling behaviors. In response to the measured usage trends indicating that a device is approaching or exceeding its rated limit, the orchestrator 110 triggers a predictive failure flag and propagates this state to the orchestration layer responsible for remediation ticket generation. Through continuous cross-correlation of cycle telemetry and firmware data, the orchestrator provides an accurate assessment of wear-based hardware reliability, thereby enabling proactive replacement or reallocation of failing components.

In some aspects, the orchestrator 110 analyzes the telemetry data objects and/or the reliability metrics by applying component-specific failure behavior models that interpret manufacturer-specific error semantics such as Self-Monitoring, Analysis, and Reporting Technology (SMART) attributes used by storage devices. The orchestrator 110 may retrieve and normalize SMART parameter sets from telemetry data objects across multiple drive vendors, mapping diverse attribute identifiers and value scales into a standardized internal schema. The component performance algorithm consults component failure rules to determine how each vendor defines critical thresholds or weighting factors for attributes such as reallocated sectors, pending sectors, or uncorrectable error counts. The component performance algorithm evaluates the normalized metrics within the context of each vendor’s defined reliability semantics to correctly interpret whether observed parameter deviations represent recoverable noise or true predictive faults. The orchestrator 110 may further integrate contextual signals such as firmware version or controller family to adjust interpretation accuracy for each device lineage. By enforcing this manufacturer-aware analytic approach, the orchestrator 110 allows consistent and precise hardware performance diagnosis across heterogeneous component inventories in the computing environment.

In some aspects, the orchestrator 110 analyzes the telemetry data objects by correlating environmental and lifecycle variables with component performance to produce short-term forecasts (such as 28-day predictions) of imminent hardware failures. The orchestrator 110 may capture telemetry data objects related to ambient temperature, humidity, power cycles, and system-uptime age alongside performance counters and reliability metrics. The component performance algorithm applies multi-variable regression and correlation analysis to determine how environmental stressors and lifecycle stages accelerate degradation patterns relative to baseline norms stored in the curated reliability database. The component performance algorithm may weigh environmental factors dynamically based on recent volatility, prioritizing sudden temperature spikes or excessive duty cycles as high-impact predictors. The orchestrator 110 integrates the weighted correlations into a temporal model that extrapolates the probability of hardware failure within the defined 28-day window. The result is stored in the fleet health repository and used to pre-stage prescriptive maintenance workflows via connected orchestration modules. By utilizing environmental and lifecycle correlations in this predictive framework, the orchestrator 110 enables accurate short-term forecasting that reduces downtime and enhances fleet-wide operational reliability.

The orchestrator 110 identifies 840 a hardware component in a computing system indicative of a hardware failure based on results of the component performance algorithm. In some examples, the orchestrator 110 identifies the hardware component 122 indicative of a hardware failure by evaluating the results of the component performance algorithm. In some cases, the component performance algorithm assigns a failure indicator value based on the results. The orchestrator 110 may retrieve the results from the component performance algorithm (such as error-rate trajectories, latency trends, and lifecycle-based endurance data), and compare the results to predefined failure rules and reliability thresholds. The component performance algorithm may populate a numerical or categorical failure indicator responsive to one or more monitored parameters deviate beyond acceptable limits, signifying operational degradation or a predicted failure event. The orchestrator 110 evaluates the indicator in conjunction with contextual attributes (such as firmware version, operating temperature, or vendor-specific tolerance data) to confirm that the anomaly is hardware-based. In response to validating to indicator, the orchestrator 110 updates a fleet health record and initiates a prescriptive remediation workflow to address the diagnosed failure. By analyzing the results of the component performance algorithm in this structured manner, the orchestrator 110 allows accurate identification of failing components and enables timely automated maintenance actions that preserve system reliability.

In some examples, the orchestrator 110 identifies the hardware component 122 experiencing failure by using component identifier information produced in the results of the component performance algorithm. The orchestrator 110 may correlate the failure event output with metadata tags associated with the telemetry data objects. The metadata tags may include serial number, UUID, bus address, logical slot designation, and/or the like. The orchestrator 110 processes the metadata tags to resolve the unique hardware component ID associated with the identified failure indicator and validates linkage against the fleet inventory. The orchestrator 110 may verify consistency of the identified component by cross-referencing device descriptors stored in configuration records, ensuring that the reported failure corresponds to an existing and active hardware element in the fleet. By associating the performance component algorithm results with component identifiers, the orchestrator 110 enables targeted, automated remediation of failing hardware and allows end to end traceability across diagnostic, repair, and validation processes.

The orchestrator 110 updates 850 a maintenance dashboard. The component performance system 220 may send telemetry data objects including failure predictions, chassis positions, and operational trends to the ticketing system 240. The ticketing system 240 may send a predictive maintenance ticket to a maintenance dashboard layer via an internal API.

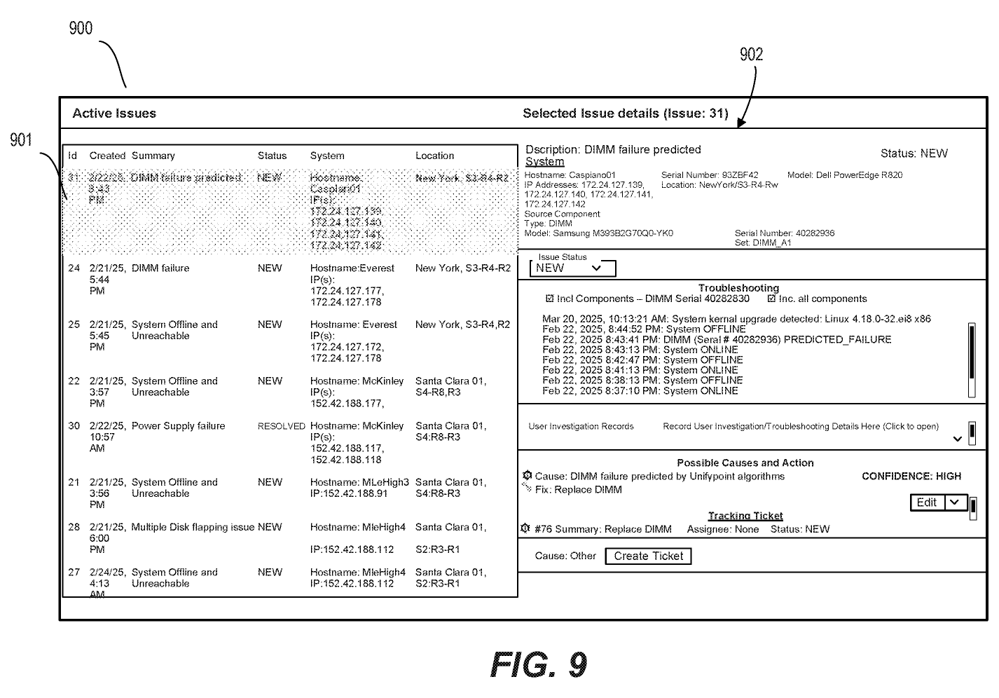

The dashboard receives the predictive maintenance ticket and parses the ticket into structured graphical elements (such as tables and charts as illustrated in FIG. 9). The dashboard refreshes the render state to reflect the latest predictive maintenance outcomes. The dashboard provides real-time predictive insight into component health status and maintenance forecasts for the entire computing infrastructure. In some examples, the maintenance dashboard operates as an interactive visualization interface that indicates the diagnostic status of components within the information technology infrastructure.

In some examples, the maintenance dashboard updates its interface to include detailed positional and inventory metadata related to hardware components and their designated replacements. The orchestrator 110 aggregates the chassis data (such as vendor silkscreen identifiers indicating chassis positions like “DIMM A2” or “PCI 3”) alongside replacement component records retrieved from the configuration management and inventory databases. By incorporating chassis mapping and physical storage location details into the maintenance dashboard’s update cycle, the system provides a comprehensive end-to-end view of component diagnostics, replacement readiness, and physical asset traceability within the computing infrastructure.

### EXAMPLE INTERFACE

FIG. 9 illustrates an example maintenance dashboard generated and presented by the orchestrator 110. In some examples, interface 900 represents a computer-implemented interface configured to manage predictive and detected failures across a fleet of computing systems. The interface 900 may be generated by the orchestrator 110. The interface 900 may include display components that render lists of ongoing issues in tabular form together with associated object metadata. Issue information may include unique identifiers, timestamps, hostnames, IP address lists, locations, and detection states (for example, “NEW,” “RESOLVED,” or “PREDICTED_FAILURE”).

In some examples, maintenance dashboard element 901 may correspond to hardware or software component degradation detected within the computing system 120. The maintenance dashboard element 901 may be dynamically sortable and filterable by parameters such as creation time, system name, or failure type. Data in maintenance dashboard element 901 may derive from structured JSON objects transmitted from the agent 124 to the orchestrator 110. In response to arrival, the orchestrator 110 parses the objects, classifies the failure type (for example, “DIMM failure”), and appends structured metadata, including hostname and IP range, to the issue list. The orchestrator 110 may assign a unique issue identifier and persists the record in the fleet health database, maintaining a continuous audit trail of predicted and actual failures.

In some examples, the maintenance dashboard element 901 may be associated with a detail panel 902. The detail panel 902 may provide expanded data regarding a specific issue selected from the maintenance dashboard element 901. The panel 902 may display component metadata such as serial number, vendor, model, slot designation, and physical location coordinates (for example, data-center row and rack identifiers). The backend populates the detail panel 902 by cross-referencing machine telemetry with stored infrastructure inventory. As shown, the detail panel 902 present hardware component the orchestrator 110 identifies as predicted failure.

### EXAMPLE COMPUTING COMPONENTS

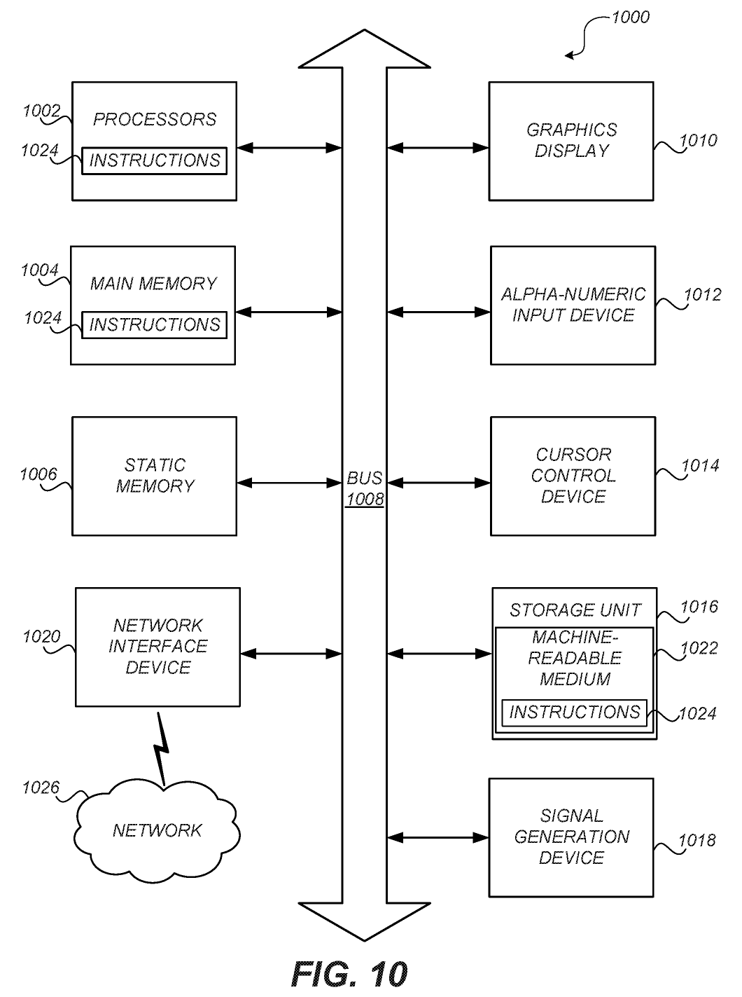

FIG. 10 is a block diagram illustrating components of an example computing machine that is capable of reading instructions from a computer-readable medium and executing them in a processor (or controller). A computer described herein may include a single computing machine shown in FIG. 10, a virtual machine, a distributed computing system that includes multiple nodes of computing machines, or any other suitable arrangement of computing devices.

By way of example, FIG. 10 shows a diagrammatic representation of a computing machine in the example form of a computer system 1000 within which instructions 1024 (for example, software, source code, program code, expanded code, object code, assembly code, or machine code), which may be stored in a computer-readable medium for causing the machine to perform any one or more of the processes discussed herein may be executed. In some aspects, the computing machine operates as a standalone device or may be connected (for example, networked) to other machines. In a networked deployment, the machine may operate in the capacity of a server machine or a client machine in a server-client network environment, or as a peer machine in a peer-to-peer (or distributed) network environment.

The structure of a computing machine described in FIG. 10 may correspond to any software, hardware, or combined components shown in FIGS. 1, 2, and 3, including but not limited to, the client device 140, the orchestrator 110, and various engines, interfaces, terminals, and machines shown in FIG. 2. While FIG. 10 shows various hardware and software elements, each of the components described in FIGS. 1, 2, and 3 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1024 that specify actions to be taken by that machine. Further, while only a single machine is illustrated, the terms “machine” and “computer” may also be taken to include any collection of machines that individually or jointly execute instructions 1024 to perform any one or more of the methodologies discussed herein.

The example computer system 1000 includes one or more processors 1002 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 1000 may also include a memory 1004 that stores computer code including instructions 1024 that may cause the processors 1002 to perform certain actions when the instructions are executed, directly or indirectly by the processors 1002. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One or more methods described herein improve the operation speed of the processor 1002 and reduce the space required for the memory 1004. For example, the database processing techniques and machine learning methods described herein reduce the complexity of the computation of the processors 1002 by applying one or more novel techniques that simplify the steps in training, reaching convergence, and generating results of the processors 1002. The algorithms described herein also reduce the size of the models and datasets to reduce the storage space requirement for memory 1004.

The performance of certain operations may be distributed among more than one processor, not only residing within a single machine but deployed across a number of machines. In some example aspects, the one or more processors or processor-implemented modules may be located in a single geographic location (for example, within a home environment, an office environment, or a server farm). In other example aspects, one or more processors or processor-implemented modules may be distributed across a number of geographic locations. Even though the specification or the claims may refer to some processes to be performed by a processor, this may be construed to include a joint operation of multiple distributed processors. In some aspects, a computer-readable medium comprises one or more computer-readable media that, individually, together, or distributively, comprise instructions that, when executed by one or more processors, cause the one or more processors to perform, individually, together, or distributively, the steps of the instructions stored on the one or more computer-readable media. Similarly, a processor comprises one or more processors or processing units that, individually, together, or distributively, perform the steps of instructions stored on a computer-readable medium. In various aspects, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

The computer system 1000 may include a main memory 1004, and a static memory 1006, which are configured to communicate with each other via a bus 1008. The computer system 1000 may further include a graphics display unit 1010 (for example, a plasma display panel (PDP), a liquid crystal display (LCD), a projector, or a cathode ray tube (CRT)). The graphics display unit 1010, controlled by the processor 1002, displays a GUI to display one or more results and data generated by the processes described herein. The computer system 1000 may also include an alphanumeric input device 1012 (for example, a keyboard), a cursor control device 1014 (for example, a mouse, a trackball, a joystick, a motion sensor, or other pointing instruments), a storage unit 1016 (a hard drive, a solid-state drive, a hybrid drive, a memory disk, etc.), a signal generation device 1018 (for example, a speaker), and a network interface device 1020, which also are configured to communicate via the bus 1008.

The storage unit 1016 includes a computer-readable medium 1022 on which is stored instructions 1024 embodying any one or more of the methodologies or functions described herein. The instructions 1024 may also reside, completely or at least partially, within the main memory 1004 or within the processor 1002 (for example, within a processor’s cache memory) during execution thereof by the computer system 1000, the main memory 1004 and the processor 1002 also constituting computer-readable media. The instructions 1024 may be transmitted or received over a network 1026 via the network interface device 1020.

While computer-readable medium 1022 is shown in an example aspect to be a single medium, the term “computer-readable medium” should be taken to include a single medium or multiple media (for example, a centralized or distributed database, or associated caches and servers) able to store instructions (for example, instructions 1024). The computer-readable medium may include any medium that is capable of storing instructions (for example, instructions 1024) for execution by the processors (for example, processors 1002) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### CLAUSES

Clause 1. A computer-implemented method, comprising: receiving, from a software agent, telemetry data objects associated with operation of a hardware component, wherein the telemetry data objects include chassis position of the hardware component installed in a computing system, wherein the software agent is deployed on the computing system; performing replacement component identification for the hardware component, wherein performing the replacement component identification comprises: obtaining a reliability metric associated with the hardware component based on the telemetry data objects; detecting performance decline of the hardware component based on the reliability metric; diagnosing the performance decline as a hardware failure; responsive to diagnosing the performance decline as the hardware failure, identifying a replacement component for the hardware component, wherein the replacement component is compatible with the chassis position; and obtaining a physical storage location of the replacement component; and updating a maintenance queue with the performance decline of the hardware component, the replacement component, and the chassis position.

Clause 2. The computer-implemented method of clause 1, wherein detecting the performance decline comprises performing trend analysis by pre-processing the telemetry data objects through time-series aggregation for a time window and comparing the telemetry data objects of the time window to a rolling average to identify gradual performance deterioration patterns relative to a baseline operation profile, wherein the baseline operation profile is associated with the hardware component.

Clause 3. The computer-implemented method of any preceding clause, wherein detecting the performance decline comprises comparing the telemetry data objects to threshold conditions based on a heuristic rule set, wherein the heuristic rule set includes count-based, vendor-specific thresholds, or type-specific thresholds.

Clause 4. The computer-implemented method of any preceding clause, wherein detecting the performance decline comprises performing diff analysis of string-level differences and numerical deltas of the telemetry data objects.

Clause 5. The computer-implemented method of any preceding clause, wherein diagnosing the performance decline as the hardware failure comprises measuring current telemetry of the hardware component against predefined threshold reliability metrics, wherein the predefined threshold reliability metrics include AFR, MTBF, or availability metric.

Clause 6. The computer-implemented method of any preceding clause, wherein the telemetry data objects comprise component-specific identifiers, performance metrics, operational status information, slot identifications, peripheral component information, and vendor-specific labeling schemes.

Clause 7. The computer-implemented method of any preceding clause, wherein the software agent corresponds to an operating system of the computing system.

Clause 8. The computer-implemented method of any preceding clause, wherein receiving the telemetry data objects further comprises receiving the telemetry data objects at a predetermined frequency.

Clause 9. The computer-implemented method of any preceding clause, wherein receiving the telemetry data objects further comprises receiving the telemetry data objects in response to a predetermined event.

Clause 10. The computer-implemented method of any preceding clause, further comprising identifying a vendor-supplied ID of the telemetry data objects is a string including a same number.

Clause 11. The computer-implemented method of any preceding clause, further comprising generating a unique ID to replace the vendor-supplied ID to track performance of the hardware component.

Clause 12. A system, comprising: a software agent, deployed on a computing system, configured to provide telemetry data objects associated with operation of a hardware component, wherein the hardware component is installed in the computing system; and an orchestrator engine, coupled to the software agent, wherein the orchestrator engine comprises: a processor; and a non-transitory computer readable storage medium having instructions encoded thereon that, when executed by the processor, cause the processor to perform steps comprising: receive, from the software agent, telemetry data objects associated with operation of the hardware component, wherein the telemetry data objects include chassis position of the hardware component installed in the computing system; perform replacement component identification for the hardware component, wherein performing the replacement component identification comprises: obtaining a reliability metric associated with the hardware component based on the telemetry data objects; detecting performance decline of the hardware component based on the reliability metric; diagnosing the performance decline as a hardware failure; responsive to diagnosing the performance decline as the hardware failure, identifying a replacement component for the hardware component, wherein the replacement component is compatible with the chassis position; and obtaining a physical storage location of the replacement component; and update a maintenance queue with the performance decline of the hardware component, the replacement component, and the chassis position.

Clause 13. The system of any preceding clause, wherein the instructions, when executed by the processor, further include steps of performing trend analysis by pre-processing the telemetry data objects through time-series aggregation for a time window and comparing the telemetry data objects of the time window to a rolling average to identify gradual performance deterioration patterns relative to a baseline operation profile, wherein the baseline operation profile is associated with the hardware component.

Clause 14. The system of any preceding clause, wherein the instructions, when executed by the processor, further include steps of comparing the telemetry data objects to threshold conditions based on a heuristic rule set, wherein the heuristic rule set includes count-based, vendor-specific thresholds, or type-specific thresholds.

Clause 15. The system of any preceding clause, wherein the instructions, when executed by the processor, further include steps of performing diff analysis of string-level differences and numerical deltas of the telemetry data objects.

Clause 16. The system of any preceding clause, wherein the instructions, when executed by the processor, further include steps of measuring current telemetry of the hardware component against predefined threshold reliability metrics, wherein the predefined threshold reliability metrics include AFR, MTBF, or availability metric.

Clause 17. The system of any preceding clause, wherein the telemetry data objects comprise component-specific identifiers, performance metrics, operational status information, slot identifications, peripheral component information, and vendor-specific labeling schemes.

Clause 18. The system of any preceding clause, wherein the software agent corresponds to an operating system of the computing system.

Clause 19. The system of any preceding clause, wherein the instructions, when executed by the processor, further include steps of: identifying a vendor-supplied ID of the telemetry data objects is a string including a same number; and generating a unique ID to replace the vendor-supplied ID to track performance of the hardware component.

Clause 20. A computer program product comprising a non-transitory computer readable storage medium having instructions encoded thereon that, when executed by a processor, cause the processor to perform steps comprising: receiving, from a software agent, telemetry data objects associated with operation of a hardware component, wherein the telemetry data objects include chassis position of the hardware component installed in a computing system, wherein the software agent is deployed on the computing system; performing replacement component identification for the hardware component, wherein performing the replacement component identification comprises: obtaining a reliability metric associated with the hardware component based on the telemetry data objects; detecting performance decline of the hardware component based on the reliability metric; diagnosing the performance decline as a hardware failure; responsive to diagnosing the performance decline as the hardware failure, identifying a replacement component for the hardware component, wherein the replacement component is compatible with the chassis position; and obtaining a physical storage location of the replacement component; and updating a maintenance queue with the performance decline of the hardware component, the replacement component, and the chassis position.

Clause 21. A computer-implemented method, comprising: performing predictive identification of hardware failures for a fleet of computing systems, wherein performing the predictive identification of failures comprises: receiving, from software agents, telemetry data objects associated with operation of hardware components installed on the computing systems, wherein the software agents are deployed across the fleet of computing systems, wherein the telemetry data objects include chassis position of the hardware components in the fleet of computing systems; obtaining reliability metrics associated with the hardware components based on the telemetry data objects; analyzing the telemetry data objects and the reliability metrics by using a component performance algorithm, wherein the component performance algorithm compares the telemetry data objects and the reliability metrics to component-specific failure rules; and identifying a hardware component in a computing system indicative of a hardware failure based on results of the component performance algorithm; and updating a maintenance dashboard with the results of the component performance algorithm, wherein the maintenance dashboard identifies the hardware component indicative of the hardware failure, including the chassis position of the hardware component in the computing system.

Clause 22. The computer-implemented method of any preceding clause, wherein the component performance algorithm computes rolling averages of the telemetry data objects and the reliability metrics to model error rate trajectories over operational intervals.

Clause 23. The computer-implemented method of any preceding clause, wherein the component performance algorithm computes time-differentiated slopes of the telemetry data objects and the reliability metrics to model error rate trajectories over operational intervals.

Clause 24. The computer-implemented method of any preceding clause, wherein the component performance algorithm performs curve-fitting to locate inflection points, wherein the inflection points indicate an error rate acceleration surpasses a defined threshold, wherein the defined threshold is based on historical norms.

Clause 25. The computer-implemented method of any preceding clause, wherein the component-specific failure rules correspond to a type of the hardware component.

Clause 26. The computer-implemented method of any preceding clause, wherein a first component-specific failure rule corresponds to a first type of hardware component and a second component-specific failure rule corresponds to a second type of hardware component different than the first type.

Clause 27. The computer-implemented method of any preceding clause, wherein the component-specific failure rules comprise one or more of vendor-specific error codes, firmware issues, patterns of component change history, failure modes appearing as multi-device flapping count of permitted read and write cycles.

Clause 28. A system, comprising: software agents, deployed on a fleet of computing systems, wherein the software agents are configured to provide telemetry data objects associated with operation of a corresponding hardware component, wherein the corresponding hardware component is installed in the fleet of computing systems; and an orchestrator engine, coupled to the software agents, wherein the orchestrator engine comprises: a processor; and a non-transitory computer readable storage medium having instructions encoded thereon that, when executed by the processor, cause the processor to perform steps comprising: performing predictive identification of hardware failures for the fleet of computing systems, wherein performing the predictive identification of failures comprises: receiving, from the software agents, telemetry data objects, wherein the telemetry data objects include chassis position of hardware components in the fleet of computing systems; obtaining reliability metrics associated with the hardware components based on the telemetry data objects; analyzing the telemetry data objects and the reliability metrics by using a component performance algorithm, wherein the component performance algorithm compares the telemetry data objects and the reliability metrics to component-specific failure rules; and identifying a hardware component in a computing system indicative of a hardware failure based on results of the component performance algorithm; and updating a maintenance dashboard with the results of the component performance algorithm, wherein the maintenance dashboard identifies the hardware component indicative of the hardware failure, including the chassis position of the hardware component in the computing system.

Clause 29. The system of any preceding clause, wherein the component performance algorithm computes rolling averages of the telemetry data objects and the reliability metrics to model error rate trajectories over operational intervals.

Clause 30. The system of any preceding clause, wherein the component performance algorithm computes time-differentiated slopes of the telemetry data objects and the reliability metrics to model error rate trajectories over operational intervals.

Clause 31. The system of any preceding clause, wherein the component performance algorithm performs curve-fitting to locate inflection points, wherein the inflection points indicate an error rate acceleration surpasses a defined threshold, wherein the defined threshold is based on historical norms.

Clause 32. The system of any preceding clause, wherein the component-specific failure rules correspond to a type of the hardware component.

Clause 33. The system of any preceding clause, wherein a first component-specific failure rule corresponds to a first type of hardware component and a second component-specific failure rule corresponds to a second type of hardware component different than the first type.

Clause 34. The system of any preceding clause, wherein the component-specific failure rules comprise one or more of vendor--specific error codes, firmware issues, patterns of component change history, failure modes appearing as multi--device flapping count of permitted read and write cycles.

Clause 35. A computer program product comprising a non-transitory computer readable storage medium having instructions encoded thereon that, when executed by a processor, cause the processor to perform steps comprising: performing predictive identification of hardware failures for a fleet of computing systems, wherein performing the predictive identification of failures comprises: receiving, from software agents, telemetry data objects associated with operation of hardware components installed on the computing systems, wherein the software agents are deployed across the fleet of computing systems, wherein the telemetry data objects include chassis position of the hardware components in the fleet of computing systems; obtaining reliability metrics associated with the hardware components based on the telemetry data objects; analyzing the telemetry data objects and the reliability metrics by using a component performance algorithm, wherein the component performance algorithm compares the telemetry data objects and the reliability metrics to component-specific failure rules; and identifying a hardware component in a computing system indicative of a hardware failure based on results of the component performance algorithm; and updating a maintenance dashboard with the results of the component performance algorithm, wherein the maintenance dashboard identifies the hardware component indicative of the hardware failure, including the chassis position of the hardware component in the computing system.

Clause 36. The non-transitory computer readable storage medium of any preceding clause, wherein the component performance algorithm computes rolling averages of the telemetry data objects and the reliability metrics to model error rate trajectories over operational intervals.

Clause 37. The non-transitory computer readable storage medium of any preceding clause, wherein the component performance algorithm computes time-differentiated slopes of the telemetry data objects and the reliability metrics to model error rate trajectories over operational intervals.

Clause 38. The non-transitory computer readable storage medium of any preceding clause, wherein the component performance algorithm performs curve-fitting to locate inflection points, wherein the inflection points indicate an error rate acceleration surpasses a defined threshold, wherein the defined threshold is based on historical norms.

Clause 39. The non-transitory computer readable storage medium of any preceding clause, wherein the component-specific failure rules correspond to a type of the hardware component.

Clause 40. The non-transitory computer readable storage medium of any preceding clause, wherein a first component-specific failure rule corresponds to a first type of hardware component and a second component-specific failure rule corresponds to a second type of hardware component different than the first type.

### ADDITIONAL CONSIDERATIONS

The foregoing description of the aspects has been presented for the purpose of illustration; it is not intended to be exhaustive or to limit the patent rights to the precise forms disclosed. Persons skilled in the relevant art can appreciate that many modifications and variations are possible in light of the above disclosure.

Aspects according to the invention are in particular disclosed in the attached claims directed to a method and a computer program product, wherein any feature mentioned in one claim category, for example, method, can be claimed in another claim category, for example, computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter that can be claimed comprises not only the combinations of features as set out in the disclosed aspects but also any other combination of features from different aspects. Various features mentioned in the different aspects can be combined with explicit mentioning of such combination or arrangement in an example aspect. Furthermore, any of the aspects and features described or depicted herein can be claimed in a separate claim and/or in any combination with any aspect or feature described or depicted herein or with any of the features.

Some portions of this description describe the aspects in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one aspect, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that are issue on an application based hereon. Accordingly, the disclosure of the aspects is intended to be illustrative, but not limited, of the scope of the patent rights.

What is claimed is:

1. A computer-implemented method, comprising:
performing predictive identification of hardware failures for a fleet of computing systems, wherein performing the predictive identification of failures comprises:
receiving, from software agents, telemetry data objects associated with operation of hardware components installed on the computing systems, wherein the software agents are deployed across the fleet of computing systems, wherein the telemetry data objects include chassis position of the hardware components in the fleet of computing systems;
obtaining reliability metrics associated with the hardware components based on the telemetry data objects;
analyzing the telemetry data objects and the reliability metrics by using a component performance algorithm, wherein the component performance algorithm compares the telemetry data objects and the reliability metrics to component-specific failure rules; and
identifying a hardware component in a computing system indicative of a hardware failure based on results of the component performance algorithm; and
updating a maintenance dashboard with the results of the component performance algorithm, wherein the maintenance dashboard identifies the hardware component indicative of the hardware failure, including the chassis position of the hardware component in the computing system.

2. The computer-implemented method of claim 1, wherein the component performance algorithm computes rolling averages of the telemetry data objects and the reliability metrics to model error rate trajectories over operational intervals.

3. The computer-implemented method of claim 2, wherein the component performance algorithm computes time-differentiated slopes of the telemetry data objects and the reliability metrics to model error rate trajectories over operational intervals.

4. The computer-implemented method of claim 2, wherein the component performance algorithm performs curve-fitting to locate inflection points, wherein the inflection points indicate an error rate acceleration surpasses a defined threshold, wherein the defined threshold is based on historical norms.

5. The computer-implemented method of claim 1, wherein the component-specific failure rules correspond to a type of the hardware component.

6. The computer-implemented method of claim 5, wherein a first component-specific failure rule corresponds to a first type of hardware component and a second component-specific failure rule corresponds to a second type of hardware component different than the first type.

7. The computer-implemented method of claim 1, wherein the component-specific failure rules comprise one or more of vendor-specific error codes, firmware issues, patterns of component change history, failure modes appearing as multi-device flapping count of permitted read and write cycles.

8. A system, comprising:
software agents, deployed on a fleet of computing systems, wherein the software agents are configured to provide telemetry data objects associated with operation of a corresponding hardware component, wherein the corresponding hardware component is installed in the fleet of computing systems; and
an orchestrator engine, coupled to the software agents, wherein the orchestrator engine comprises:
a processor; and
a non-transitory computer readable storage medium having instructions encoded thereon that, when executed by the processor, cause the processor to perform steps comprising:
performing predictive identification of hardware failures for the fleet of computing systems, wherein performing the predictive identification of failures comprises:
receiving, from the software agents, telemetry data objects, wherein the telemetry data objects include chassis position of hardware components in the fleet of computing systems;
obtaining reliability metrics associated with the hardware components based on the telemetry data objects;
analyzing the telemetry data objects and the reliability metrics by using a component performance algorithm, wherein the component performance algorithm compares the telemetry data objects and the reliability metrics to component-specific failure rules; and
identifying a hardware component in a computing system indicative of a hardware failure based on results of the component performance algorithm; and
updating a maintenance dashboard with the results of the component performance algorithm, wherein the maintenance dashboard identifies the hardware component indicative of the hardware failure, including the chassis position of the hardware component in the computing system.

9. The system of claim 8, wherein the component performance algorithm computes rolling averages of the telemetry data objects and the reliability metrics to model error rate trajectories over operational intervals.

10. The system of claim 9, wherein the component performance algorithm computes time-differentiated slopes of the telemetry data objects and the reliability metrics to model error rate trajectories over operational intervals.

11. The system of claim 9, wherein the component performance algorithm performs curve-fitting to locate inflection points, wherein the inflection points indicate an error rate acceleration surpasses a defined threshold, wherein the defined threshold is based on historical norms.

12. The system of claim 8, wherein the component-specific failure rules correspond to a type of the hardware component.

13. The system of claim 12, wherein a first component-specific failure rule corresponds to a first type of hardware component and a second component-specific failure rule corresponds to a second type of hardware component different than the first type.

14. The system of claim 8, wherein the component-specific failure rules comprise one or more of vendor--specific error codes, firmware issues, patterns of component change history, failure modes appearing as multi--device flapping count of permitted read and write cycles.

15. A computer program product comprising a non-transitory computer readable storage medium having instructions encoded thereon that, when executed by a processor, cause the processor to perform steps comprising:
performing predictive identification of hardware failures for a fleet of computing systems, wherein performing the predictive identification of failures comprises:
receiving, from software agents, telemetry data objects associated with operation of hardware components installed on the computing systems, wherein the software agents are deployed across the fleet of computing systems, wherein the telemetry data objects include chassis position of the hardware components in the fleet of computing systems;
obtaining reliability metrics associated with the hardware components based on the telemetry data objects;
analyzing the telemetry data objects and the reliability metrics by using a component performance algorithm, wherein the component performance algorithm compares the telemetry data objects and the reliability metrics to component-specific failure rules; and
identifying a hardware component in a computing system indicative of a hardware failure based on results of the component performance algorithm; and
updating a maintenance dashboard with the results of the component performance algorithm, wherein the maintenance dashboard identifies the hardware component indicative of the hardware failure, including the chassis position of the hardware component in the computing system.

16. The non-transitory computer readable storage medium of claim 15, wherein the component performance algorithm computes rolling averages of the telemetry data objects and the reliability metrics to model error rate trajectories over operational intervals.

17. The non-transitory computer readable storage medium of claim 16, wherein the component performance algorithm computes time-differentiated slopes of the telemetry data objects and the reliability metrics to model error rate trajectories over operational intervals.

18. The non-transitory computer readable storage medium of claim 16, wherein the component performance algorithm performs curve-fitting to locate inflection points, wherein the inflection points indicate an error rate acceleration surpasses a defined threshold, wherein the defined threshold is based on historical norms.

19. The non-transitory computer readable storage medium of claim 15, wherein the component-specific failure rules correspond to a type of the hardware component.

20. The non-transitory computer readable storage medium of claim 19, wherein a first component-specific failure rule corresponds to a first type of hardware component and a second component-specific failure rule corresponds to a second type of hardware component different than the first type.
